(19) United States
(12) Patent Application Publication
(10) Pub. No.: US 2026/0189469 A1
(43) Pub. Date: Jul. 2, 2026

(54) AI/ML MODEL APPLICABILITY MECHANISMS

(71) Applicant: RAKUTEN SYMPHONY, INC., Tokyo (JP)

(72) Inventors: Awn MUHAMMAD, Tokyo (JP); Pankaj Tanaji SHETE, Tokyo (JP)

(73) Assignee: RAKUTEN SYMPHONY, INC., Tokyo (JP)

(21) Appl. No.: 18/863,847

(22) PCT Filed: Aug. 9, 2024
(86) PCT No.: PCT/US2024/041636

§ 371 Date: Nov. 7, 2024

Related U.S. Application Data
(60) Provisional application No. 63/541,015, filed on Sep. 28, 2023.

(51) Int. Cl. H04L 41/16; H04L 43/065

(52) U.S. Cl. CPC H04L 41/16; H04L 43/065

(57) ABSTRACT

Example embodiments of the present disclosure relate to Artificial Intelligence (AI)/Machine Learning (ML) model applicability mechanisms. According to example embodiments, a device may be configured to evaluate an applicability of an AI/ML model in relation to a mobile telecommunication network and then generate a report message that includes the evaluated applicability. Subsequently, the device may provide the report message to at least one Network Element (NE) of the mobile telecommunication network.

### CROSS REFERENCE TO RELATED APPLICATION

This application claims priority to U.S. Provisional Patent Application No. 63/541,015, filed with the US Patent and Trademark Office on Sep. 28, 2023, the entire contents of which are incorporated herein by reference.

### TECHNICAL FIELD

The present disclosure relates to the Artificial Intelligence (AI)/Machine Learning (ML) model applicability mechanisms.

### BACKGROUND

The information disclosed in this background section is only for the enhancement of understanding of the general background of the disclosure and should not be taken as an acknowledgement or any form of suggestion that this information forms the prior art already known to a person skilled in the art.

With the evolvement of telecommunication technologies, the role of the Artificial Intelligence (AI) and/or Machine Learning (ML) model (may be referred to as “AI/ML model” herein) and the features enabled by the AI/ML model (may be referred to as “AI/ML-enabled feature” herein) in telecommunication networks are becoming more crucial, since the integration and implementation of the AI/ML models and the associated features may enable potential use cases for optimizing network performance, enhancing user experience, and realizing advanced functionalities such as autonomous life-cycle management (LCM) of network elements.

### SUMMARY

Example embodiments of the present disclosure provide a system, a device, a method, and the like, that leverages various novel features or mechanisms associated with AI/ML model applicability.

According to example embodiments, a device may be configured to evaluate an applicability of an AI/ML model in relation to a mobile telecommunication network and then generate a report message that includes the evaluated applicability. Subsequently, the device may provide the report message to at least one Network Element (NE) of the mobile telecommunication network.

According to example embodiments, a method may include evaluating an applicability of an AI/ML model in relation to a mobile telecommunication network, generating a report message that includes the evaluated applicability, and providing the report message to at least one NE of the mobile telecommunication network.

A non-transitory computer-readable recording medium may have recorded thereon instructions executable by a device to cause the device to perform a method including: evaluating an applicability of an AI/ML model in relation to a mobile telecommunication network, generating a report message that includes the evaluated applicability, and providing the report message to at least one NE of the mobile telecommunication network.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a block diagram of an example system architecture, according to one or more example embodiments;

FIG. 2 illustrates a block diagram of an example method for communicating AI/ML model applicability information, according to one or more example embodiments;

FIG. 3 illustrates a flow diagram of an example use case associated with proactive reporting, according to one or more example embodiments;

FIG. 4 illustrates a flow diagram of an example use case associated with reactive reporting, according to one or more example embodiments;

FIG. 5 illustrates a block diagram of an example method for dynamic threshold reporting, according to one or more example embodiments;

FIG. 6A and FIG. 6B each illustrates a flow diagram of an example use case associated with dynamic threshold adjustment, according to one or more example embodiments;

FIG. 7 illustrates a block diagram of an example method for real-time monitoring and reporting, according to one or more example embodiments;

FIG. 8 illustrates a flow diagram of an example use case associated with real-time monitoring and reporting, according to one or more example embodiments; and

FIG. 9 illustrates a device for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, and the like. For instance, the terms “RRC”, “UAI”, “NAS”, “MAC CE”, “IE”, and the like, as well as the associated features and operations, are to be interpreted as consistent with those specified in one or more technical specifications, unless being described otherwise.

Further, as used herein, the term “AI/ML applicability” may indicate whether an AI/ML technology is applicable (suitable) or not applicable (not suitable) for a particular condition, scenario, or use case. The term “AI/ML model applicability” may indicate whether an AI/ML model is applicable (suitable) or not applicable (not suitable) for a particular condition, scenario, or use case. The term “AI/ML-enabled feature applicability” may indicate whether a feature associated with an AI/ML model or an AI/ML technology is applicable (suitable) or not applicable (not suitable) for a particular condition, scenario, or use case. In this regard, the terms “AI/ML applicability”, “AI/ML model applicability”, and “AI/ML-enabled feature applicability” may be used interchangeably herein since these terms may all indicate whether or not AI/ML is applicable, unless described otherwise.

As described above, the implementation and utilization of Artificial Intelligence (AI) and/or Machine Learning (ML) in telecommunication systems have significantly increased recently, particularly due to emerging advanced telecommunication technologies such as the fifth generation (5G) network system, the open radio access network (O-RAN) architecture, and the like.

In this regard, multiple AI/ML models pertaining to the same feature may be pre-trained based on datasets associated with different aspects of network behavior and performance. For instance, a first AI/ML model associated with beamforming may be pre-trained based on data obtained from a dense urban area while a second AI/ML model associated with beamforming may be pre-trained based on data obtained from a rural environment. These pre-trained AI/ML models may be stored in an AI/ML server that may manage the deployment and updates of the AI/ML models. In operation, a User Equipment (UE) and/or a Network Element (NE) may communicate with the AI/ML server to load an AI/ML model, and then implement the associated features based thereon.

The applicability of AI/ML models (e.g., whether an AI/ML model is applicable under a specific condition) is crucial in the implementation of AI/ML features in the telecommunication system, since the AI/ML model applicability information is required to ensure accurate AI/ML model implementation. For example, an AI/ML model may differ for the UE depending on the location of the UE (e.g., when the UE is in a rural environment, the implementation of an AI/ML model that is developed for the dense urban area may result in inaccurate AI/ML performance, etc.) Similarly, an AI/ML model may also differ for the UE depending on various types of conditions, such as the network conditions, the configurations/settings of the UE, the application requirements, and the like.

In the related art, there is no interaction between the UE and the NE in the implementation of an AI/ML-enabled feature. Rather, the AI/ML model(s) to be implemented are selected by either the UE or the NE. For instance, the UE or the NE may select the AL/ML model, and activate/deactivate the AI/ML-enabled feature based on its own observation and assessment of the applicability conditions.

As a result, the selected AI/ML model is not always accurate and the implemented AI/ML feature may not operate as desired. Further, it may also increase the complexity of the Life Cycle Management (LCM), as well as increase the burden on the UE side or the network side to evaluate the AI/ML model applicability and apply the application feature. Accordingly, the UE and the NE may experience inconsistency or misalignment in terms of AI/ML functionality and performance expectations.

Example embodiments of the present disclosure provide a system, a method, a device, and the like, that implement a novel applicability framework and mechanisms that manage the AI/ML model applicability information within a mobile telecommunication network. Specifically, through the applicability framework and the associated mechanisms of example embodiments, the UE and/or the NE within the network can effectively and efficiently report and notify about the AI/ML model applicability information. Further, the UE and/or the NE can dynamically adjust or configure the thresholds and conditions that are being utilized to evaluate the AI/ML model applicability. Furthermore, the UE and/or the NE can perform real-time monitoring on performance metrics of AI/ML models and report the same to other network components. In addition, the UE and/or the NE can dynamically select appropriate AI/ML models.

It is contemplated that features, advantages, and significances of example embodiments described hereinabove are merely a portion of the present disclosure, and are not intended to be exhaustive or to limit the scope of the present disclosure. Further descriptions of the features, components, configuration, operation are provided in the following.

### Example System Architecture

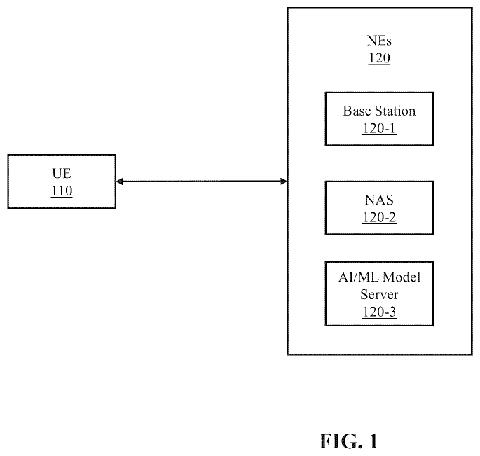

FIG. 1 illustrates a block diagram of an example system architecture, according to one or more example embodiments. As illustrated in FIG. 1, the system architecture may include at least one User Equipment (UE) 110 and a plurality of Network Elements (NEs) 120. The plurality of NEs 120 may include a base station 120-1, a Non-Access Stratum (NAS) 120-2, and an AI/ML model server 120-3. It is contemplated that the system architecture illustrated in FIG. 1 is simplified for descriptive purposes, and the scope of the present disclosure should not be limited thereto. For instance, the plurality of NEs 120 may include any other suitable NE associated with a mobile telecommunication network, without departing from the scope of the present disclosure.

The UE 110 may include one or more equipment, devices, and the like, which may be utilized by one or more network users (e.g., network operators, end users such as network subscribers, etc.) to access the network system via interoperating with one or more of the NEs 120. For example, the UE 120-2 may include one or more of: a static device (e.g., a computing device such as a desktop computer or a server, a fixed wireless access (FWA) router, an internet modem, an Internet of Things (IOT) device like a security camera, sensors, and smart home devices, etc.), etc.), a mobile device (e.g., a smartphone, a radiotelephone, a laptop computer, a tablet computer, a handheld computer, a smart device, a wearable device such as a pair of smart glasses or a smart watch, a portable hotspot, etc.), a mobile device that has been in a static state for a predetermined period of time (e.g., a mobile device that has been left on a desk or a charging station for a predetermined period of time, etc.), and/or any other suitable device or equipment.

The base station 120-1 may include at least one of: a fourth generation (4G) Long-Term-Evolution (LTE) eNodeB, a fifth generation (5G) gNodeB, and the like. According to example embodiments, the base station 120-1 may include a radio unit (RU), a distributed unit (DU), and a centralized unit (CU). According to example embodiments, the base station 120-1 may include an open radio access network (O-RAN)-based base station.

On the other hand, the NAS 120-2 may be implemented in the form of a network function (NF), such as a Virtualized NF (VNF), a containerized/cloudified NF (CNF), and the like. According to example embodiments, the NAS 120-2 may be a part of a core network element, such as a component or a function of a Mobility Management Entity (MME) in LTE or a component or a function of an Access and Mobility Management Function (AMF) in 5G. According to example embodiments, the NAS 120-2 may communicatively couple the base station 120-1 to the AI/ML model server 120-3.

As further described below, in some example embodiments, the NAS 120-1 may be involved in the signaling of AI/ML model applicability information between the UE 110 and one or more of the NEs 120. It is contemplated that, in example implementations where the AI/ML model applicability information is communicated via other types of mechanisms (e.g., RRC message signaling, PHY layer message signaling, etc.), the NAS 120-1 may be optional and may be excluded from the system architecture.

The AI/ML model server 120-3 may include one or more servers that host, manage, and process one or more AI/ML models associated with the mobile telecommunication network, The AI/MI model server 120-3 may interact with the UE 110 and other NEs 120 to communicate information associated with the one or more AI/ML models for various network-related tasks. For instance, the server 120-3 may receive data from the UE 110, the base station 120-1, and/or the NAS 120-2, and then process the received data using the AI/ML model(s). Accordingly, the server 120-3 may provide actionable insights or information associated with the AI/ML model processing to the UE 110, the base station 120-1, and/or the NAS 120-2.

The UE 110 may interoperate with one or more of the NEs 120 to implement an AI/ML model applicability framework and the associated mechanisms. For instance, the UE 110 and/or the NE(s) 120 may be configured to select an appropriate AI/ML model in relation to a mobile telecommunication network, evaluate the AI/ML model applicability, report the AI/ML model applicability information to other components within the network system, monitor and report real-time performance metrics, and dynamically adjust thresholds associated with the AI/ML model applicability. Further descriptions associated with the applicability framework and the mechanisms provided thereby are provided in the following.

### Example AI/ML Applicability Framework and Mechanisms

According to example embodiments, the system (illustrated in FIG. 1) may be configured to implement an applicability framework that enables the UE and the NE(s) to interact with each other, thereby communicating information associated with the AI/ML model applicability (may be referred to as “AI/ML model applicability information” herein).

According to example embodiments, the AI/ML model applicability information may include information of one or more applicability conditions. In this regard, the applicability framework may include the following three main components that are associated with applicability condition: applicability condition management, applicability notification, and applicability condition evaluation.

The applicability condition management may include applicability condition definition. Specifically, the applicability condition may be defined by at least one criteria or threshold that should be met in order for an associated AI/ML model or feature to be applicable under a specific scenario or use case. In this regard, the applicability condition, as well as the associated criteria or threshold, may be predefined by one or more standard technical specifications (e.g., 3GPP specifications, etc.) or by the network operator and/or the UE manufacturer according to the implementation of a particular UE and/or NE(s). Further, the applicability condition may also be static or dynamic, namely, the UE and/or NE(s) may change or adjust the applicability condition depending on various factors such as the user's capabilities, the network environment, and the specific use case, in real-time (or near-real-time).

The applicability condition evaluation may include determining whether or not an AI/ML-enabled feature or model meets one or more applicability conditions. For instance, the UE and/or NE(s) may evaluate the available information or measurements to determine whether or not the AI/ML-enabled feature or model meets the applicability condition(s), depending on the collaboration level, the type of model, and the like. As further described below, the applicability condition evaluation may trigger a proactive reporting mechanism, such that the AI/ML model applicability information can be autonomously communicated between the UE and NE(s) based on the evaluation result.

The applicability notification may include notifying whether or not an AI/ML-enabled feature or model is applicable based on the evaluation result. This notification may be performed by either the UE, the NE(s), or both the UE and NE(s), depending on the collaboration level and the type of model.

In addition to features and mechanisms associated with applicability conditions, the applicability framework may also provide features and mechanisms for signaling and reporting the AI/ML model applicability result, monitoring and reporting performance metrics of the AI/ML model, and dynamically adjusting thresholds associated with AI/ML model applicability. In the following, several example features and mechanisms associated therewith are described.

### Enhanced Reporting Mechanisms

According to example embodiments, the applicability framework may provide or enable several reporting mechanisms for information exchanges between the UE and the NE(s). In some example embodiments, the UE may autonomously evaluate, based on one or more predefined conditions (e.g., applicability conditions), AI/ML model applicability and then proactively report the AI/ML model applicability to one or more NEs. This approach may be referred to as a “proactive reporting mechanism” herein, which effectively reduces latency, enhances responsiveness, and reduces network dependency.

According to example embodiments, the UE may be configured to perform proactive reporting according to a predefined algorithm. The algorithm may be designed by, for example, the network operator and/or the UE manufacturer, and may be utilized by the UE and/or the NE(s) to evaluate AI/ML model applicability condition(s). An example algorithm according to example embodiments is presented in the following Table 1.

TABLE 1
Example Algorithm of AI/ML Model Applicability
Proactive Evaluation

```
Algorithm_AIML_Proactive_Evaluation {
  input: [channel_conditions, mobility_status,
  application_requirements, battery_level];
  output: applicability_result;
  steps: [
  evaluate(channel_conditions),
  check(mobility_status),
  analyze(application_requirements),
  verify(battery_level),
  determine(applicability_result)
  ];
}
```

In the example of Table 1, information associated with several conditions (e.g., channel conditions, mobility status of a UE, application requirements, battery level of a UE, etc.) are obtained by the UE and/or NE(s) and said conditions are processed (e.g., evaluated, checked, analyzed, verified, etc.) by the UE and/or NE(s) to thereby determine the applicability result (e.g., applicable, non-applicable, unknown). As a non-limiting example, the UE and/or NE(s) may compare the battery level of the UE with a predefined threshold, and then determine that the AI/ML model is applicable based on determining that said battery level is lower than the predefined threshold. Thus, said condition(s) may also be referred to as “applicability condition(s)” herein.

According to example embodiments, the proactive reporting may be triggered or initiated based on at least one predefined condition. Thus, said predefined condition may also be referred to as a “triggering condition” herein. In this regard, the triggering condition(s) may be predefined by the network operator and/or the UE manufacturer to ensure that the proactive reporting is triggered in a standardized and uniform manner, thereby ensuring that the applicability evaluation and proactive reporting are consistent, reliable, and tailored to specific network requirement(s). In some example implementations, the triggering condition may include at least one predefined activation condition associated with a functionality of the UE and/or a functionality of the NE(s), The predefined activation condition(s) may provide clarity on the condition(s) required for activating functionalities (e.g., evaluation of the AI/MI model applicability, etc.), thereby ensuring that the intended condition(s) is met and verified before the activation and enhancing operational reliability. It is contemplated that the terms “triggering condition” and “activation condition” may be used interchangeably, without departing from the scope of the present disclosure.

Several example triggering conditions, according to example embodiments, are presented in the following Table 2.

TABLE 2
Example Triggering Conditions

Triggering_Conditions {
condition_1: channel_conditions_change > threshold;
condition_2: mobility_status_change == high_speed;
condition_3: battery_level < low_threshold;
}

Table 2 illustrates a plurality of triggering conditions, namely, conditions 1-3. Condition 1 is defined by a comparison of a change in the channel condition with a first predefined threshold (i.e., change in channel condition is greater than the first predefined threshold), condition 2 is defined by a comparison of a change in the mobility status of the UE with a second predefined threshold (i.e., change in the mobility status is equal to a threshold associated with high speed), and condition 3 is defined by a comparison of a battery level of the UE with a third predefined threshold (i.e., the battery level is lower than a threshold associated with low battery level). It is contemplated that the triggering conditions in Table 2 are merely examples and the scope of the present disclosure should not be limited thereto.

According to example embodiments, the UE and/or NE(s) may be configured to generate a report message during the proactive reporting (may be referred to as “proactive report message” herein). Accordingly, the UE and/or NE(s) may provide the report message to the NE(s) and/or UE, via various types of signaling mechanisms (further described below), thereby enabling the communication of AUML model applicability information therebetween. An example proactive report message, according to one or more example embodiments, is presented in the following Table 3,

TABLE 3
Example Proactive Report Message

```
Proactive_Report_Message {
  ai_ml_feature_id: INTEGER (1..1024),
  applicability_result: ENUMERATED {applicable,
  not_applicable, unknown},
  evaluation_parameters: SEQUENCE {
    channel_conditions: INTEGER,
    mobility_status: ENUMERATED {stationary, moving, high_speed},
    battery_level: ENUMERATED {high, medium, low}
  }
  }
```

As illustrated in Table 3, the proactive report message may include an identifier (ID) associated with an AI/ML feature (e.g., an integer between 1 to 1024, etc.), an AI/ML model applicability result (e.g., applicable, not applicable, unknown, etc.), and at least one evaluation parameter utilized by the UE and/or NE(s) to perform the applicability evaluation (e.g., channel conditions, mobility status, battery level, etc.)

According to example embodiments where the UE is configured to perform the proactive reporting, the NE(s) may provide information associated with the triggering condition(s) to the UE. For instance, the NE(s) may generate a configuration message that contains the information of the triggering condition(s) (may be referred to as “trigger configuration message” herein) and then provide the configuration message to the UE, thereby specifying the triggering condition(s) for proactive reporting and providing network-configured triggers that ensure that the UB's reporting aligns with network requirement(s) and condition(s). An example trigger configuration message, according to one or more example embodiments, is presented in the following Table 4.

TABLE 4
Example Trigger Configuration Message

```
Trigger_Configuration_Message {
  trigger_conditions: SEQUENCE {
    condition_id: INTEGER (1..256),
    condition_type: ENUMERATED {channel, mobility,
    battery, application},
    threshold_value: INTEGER,
    evaluation_interval: TIME
  }
}
```

As illustrated in Table 4, the configuration message may include detailed information associated with one or more trigger conditions, such as an ID of a triggering condition (e.g., an integer between 1 to 256, etc.), a type of the triggering condition (e.g., channel, mobility, battery, application, etc.), a threshold value associated with the triggering condition (e.g., an integer, etc.), and an evaluation interval associated with the time that the triggering condition should be evaluated.

According to example embodiments, the UE may receive the trigger configuration message from the NE(s) and then perform (e.g., periodically, continuously, etc.) an evaluation procedure on the triggering condition(s) to thereby determine whether or not the proactive reporting should be initiated. In this regard, the evaluation procedure may be pre-defined by the network operator and/or the UE manufacturer, thereby ensuring a consistent and reliable process for initiating the proactive reporting. An example structure of the evaluation procedure, according to one or more example embodiments, is presented in the following Table 5.

TABLE 5
Example Structure of Conditions Evaluation Procedure

```
Evaluation_Procedure {
  receive(trigger_configuration_message);
  evaluate_conditions(trigger_conditions);
  if (conditions_met) {
    generate(proactive_report_message);
    send(proactive_report_message);
  }
}
```

As illustrated in Table 5, the evaluation procedure may include receiving the configuration message that includes the triggering condition(s) and the associated configuration, and evaluating the triggering condition(s). For instance, upon receiving the configuration message, the UE may evaluate the trigger condition(s) to determine whether or not one or more conditions for initiating the proactive reporting procedure are met. Accordingly, based on determining that the one or more conditions are met, the UE may determine the AI/ML model applicability, generate a report message that includes the information associated with the AI/ML model applicability, and send the report message to the NE(s) thereafter.

According to example embodiments, the UE and/or the NE(s) may perform the proactive reporting via Radio Resource Control (RRC) signaling. Specifically, the UE and/or NE(s) may include the information associated with the AI/ML model applicability in an RRC Information Element (IE) and provide an RRC message that includes the RRC IE to the NE(s) and/or UE via RRC signaling, thereby ensuring that the applicability information is communicated efficiently and accurately. An example of RRC IE for proactive reporting (may be referred to as “RRC proactive report IE” herein), according to one or more example embodiments, is presented in the following Table 6.

TABLE 6
Example RRC Proactive Report IE

```
RRC_Proactive_Report_IE {
  ai_ml_feature_id: INTEGER (1..1024),
  applicability_result: ENUMERATED {applicable, not_applicable,
  unknown},
  evaluation_parameters: SEQUENCE {
    channel_conditions: INTEGER,
    mobility_status: ENUMERATED {stationary, moving, high_speed},
    battery_level: ENUMERATED {high, medium, low}
  }
}
```

As illustrated in Table 6, the RRC proactive report IE may include an ID associated with a feature of the AI/ML model (e.g., an integer between 1 to 1024, etc.), an applicability result (e.g., applicable, not applicable, unknown, etc.), and at least one evaluation parameter (e.g., channel condition, mobility status of the UE such as stationary, moving, and high speed, battery level of the UE such as high, medium, and low, etc.) It is contemplated that the RRC proactive report IE may include more/less information or parameters than illustrated in Table 6, without departing from the scope of the present disclosure. For instance, the RRC proactive report IE may further include an applicability condition associated with the applicability result, an applicability result associated with the applicability result, an action suggestion associated with the applicability result, and the like.

In addition to or in alternative to RRC signaling, the UE may also be configured to perform the proactive reporting via UE Assistance Information (UAI) signaling. Specifically, the UE may include the information associated with the AI/ML model applicability in a UAI IE in an extended UAI message, and provide the UAI message to the NE(s) via UAI signaling, thereby providing detailed applicability information and aiding in network optimization. An example of a UAI IE for proactive reporting (may be referred to as “UAI proactive report IE” herein), according to one or more example embodiments, is presented in the following Table 7.

TABLE 7
Example UAI Proactive Report IE

```
UAI_Proactive_Report_IE {
  ai_ml_feature_id: INTEGER (1..1024),
  applicability_result: ENUMERATED {applicable, not_applicable,
  unknown},
  evaluation_parameters: SEQUENCE {
    channel_conditions: INTEGER,
    mobility_status: ENUMERATED {stationary, moving, high_speed},
    battery_level: ENUMERATED {high, medium, low}
  }
}
```

Similar to the RRC proactive report IE in Table 6, the UAI proactive report IE in Table 7 may include an ID associated with a feature of the AI/ML model (e.g., an integer between 1 to 1024, etc.), an applicability result (e.g., applicable, not applicable, unknown, etc.), and at least one evaluation parameter (e.g., channel condition, mobility status of the UE such as stationary, moving, and high speed, battery level of the UE such as high, medium, and low, etc.) It is contemplated that the UAI proactive report IE may include more/less information or parameters than illustrated in Table 7, without departing from the scope of the present disclosure. For instance, the UAI proactive report IE may further include a performance metric associated with the AIML model, a training process associated with the AI/ML model, an inference accuracy associated with the AI/ML mode, information associated with data security mechanisms and privacy regulation, and the like.

According to example embodiments, the UE may be configured to perform the proactive reporting via RRC and UAI signaling. In this regard, the UE may generate and transmit the proactive reporting message(s) via RRC and UAI via a procedure predefined by the network operator and/or the UE manufacturer, thereby ensuring timely and accurate applicability reporting and enhancing network responsiveness. An example procedure of RRC and UAI proactive reporting, according to one or more example embodiments, is presented in the following Table 8.

TABLE 8
Example RRC and UAI Proactive Reporting Procedure

```
RRC_UAI_Proactive_Reporting_Procedure {
  evaluate_conditions( );
  if (conditions_met) {
    generate(RRC_Proactive_Report_IE);
    send(RRC_Proactive_Report_IE);
    generate(UAI_Proactive_Report_IE);
    send(UAI_Proactive_Report_IE);
  }
}
```

As illustrated in Table 8, during the reporting procedure, the UE may first evaluate the triggering condition(s) to determine whether or not the RRC and UAI reporting should be triggered. Accordingly, based on determining that the triggering condition(s) is met, the UE may trigger the RRC and UAI reporting, by generating the RRC proactive report IE (or an RRC message that includes the RRC proactive report IE) and the UAI proactive report IE (or a UAI message that includes the UAI proactive report IE), and sending the same to the NE(s).

In addition to or in alternative to proactive reporting, the UE may evaluate and report the AI/ML model applicability information in response to a network query. Similarly, the NE(s) may evaluate and report the AI/ML model applicability information in response to a UE query. This approach may be referred to as a “reactive reporting mechanism” herein, which effectively ensures accurate information exchange and enables the UE and/or NE(s) to efficiently and accurately provide AI/ML applicability reporting in response to network-initiated queries.

According to example embodiments, the UE may be configured to perform the reactive reporting in response to a network query message. This network query message may be provided by at least one NE (e.g., a base station) to the UE to trigger or initiate the reactive applicability reporting. An example network query message, according to one or more example embodiments, is presented in the following Table 9.

TABLE 9
Example Network Query Message

```
Network_Query_Message {
  ai_ml_feature_id: INTEGER (1..1024),
  query_parameters: SEQUENCE {
    condition_type: ENUMERATED {channel, mobility, battery,
    application},
    threshold_value: INTEGER
  }
}
```

As illustrated in Table 9, the network query message may include an ID associated with a feature of an AI/ML model (e.g., an integer between 1 to 1024, etc.) and a plurality of query parameters that include a condition type (e.g., channel, mobility, battery, application, etc.) and a threshold value associated with the condition (e.g., an integer, etc.) It is contemplated that the network query message may include more/less information or parameters than illustrated in Table 9, without departing from the scope of the present disclosure. For instance, the network query message may include any network-side additional conditions or network configurations that may impact AI/ML model applicability and influence the UE's decision-making process and reporting behavior.

Upon receiving the network query message from the NE, the UE may be configured to generate a response message (may be referred to as “UE response message” herein) that includes information associated with the AI/ML model applicability. An example UE response message, according to one or more example embodiments, is presented in the following Table 10.

TABLE 10
Example UE Response Message

```
UE_Response_Message {
  ai_ml_feature_id: INTEGER (1..1024),
  applicability_result: ENUMERATED {applicable, not_applicable,
  unknown},
  evaluation_parameters: SEQUENCE {
    channel_conditions: INTEGER,
    mobility_status: ENUMERATED {stationary, moving, high_speed},
    battery_level: ENUMERATED {high, medium, low}
  }
}
```

As illustrated in Table 10, the UE response message may include parameters or information similar to those in the RRC proactive report IE (in Table 6) and UAI proactive report IE (in Table 7). Thus, redundant descriptions associated therewith may be omitted herein for conciseness.

According to example embodiments, the UE may be configured to perform the reactive reporting via a procedure predefined by the network operator and/or the UE manufacturer, thereby ensuring a consistent and reliable process for reactive reporting. An example procedure of reactive reporting procedure, according to one or more example embodiments, is presented in the following Table 11.

TABLE 11
Example Reactive Reporting Procedure

```
Reactive_Response_Procedure {
  receive(network_query_message);
  evaluate_conditions(query_parameters);
  generate(UE_response_message);
  send(UE_response_message);
}
```

As illustrated in Table 11, the reactive reporting procedure at the UE side may include the UE receiving the network query message (e.g., network query message in Table 9, etc.), and evaluating the condition(s) defined by the query parameter(s) included in the network query message. Accordingly, the UB may generate a response message (e.g., UE response message in Table 10, etc.) and send the response message to the NE(s).

According to example embodiments, the UE may be configured to perform the reactive reporting via RRC signaling. In this regard, the UE may be configured to generate an RRC message that contains information associated with the AI/ML model applicability (may be referred to as “RRC AI/ML applicability message” herein) and then provide the same to the NE(s), thereby providing detailed applicability information and aiding in network optimization. An example RRC message, according to one or more example embodiments, is presented in the following Table 12.

TABLE 12
Example RRC Message

```
RRC_AIML_Applicability_Message {
  ai_ml_feature_id: INTEGER (1..1024),
  applicability_result: ENUMERATED {applicable, not_applicable,
  unknown},
  evaluation_parameters: SEQUENCE {
    channel_conditions: INTEGER,
    mobility_status: ENUMERATED {stationary, moving, high_speed},
    battery_level: ENUMERATED {high, medium, low}
  }
}
```

As illustrated in Table 12, the RRC message may include an ID associated with a feature of an AI/ML model (e.g., an integer between 1 to 1024, etc.), an applicability result (e.g., applicable, not applicable, unknown, etc.), and at least one evaluation parameter (e.g., channel condition, mobility status of the UE such as stationary, moving, and high speed, battery level of the UE such as high, medium, and low, etc.) It is contemplated that the RRC message may include more/less information or parameters than illustrated in Table 12, without departing from the scope of the present disclosure. For instance, the RRC message may further include an applicability condition associated with the applicability result, an action suggestion associated with the applicability result, and the like.

According to example embodiments, the UE may be configured to perform the reactive reporting via UAI signaling. In this regard, the UE may be configured to generate a UAI report message that contains information associated with the AI/ML model applicability (may be referred to as “UAI AI/ML applicability report” herein) and then provide the same to the NE(s), thereby ensuring comprehensive and clear applicability reporting. An example UAI message, according to one or more example embodiments, is presented in the following Table 13.

TABLE 13
Example UAI Message

```
UAI_AIML_Applicability_Report {
  ai_ml_feature_id: INTEGER (1..1024),
  applicability_condition: SEQUENCE {
    condition_id: INTEGER (1..256),
    result: ENUMERATED {applicable, not_applicable, unknown},
    deviation_info: SEQUENCE {
      deviation_type: ENUMERATED {performance, condition},
      deviation_value: INTEGER
    }
  }
}
```

Similar to the RRC message in Table 12, the UAI message in Table 13 may also include a feature of an AI/ML model (e.g., an integer between 1 to 1024, etc.) and an applicability result (e.g., applicable, not applicable, unknown, etc.) In addition, the UAI message may include an ID associated with an evaluated condition (e.g., an integer between 1 to 256, etc.) and information associated with a deviation of a performance of the AI/ML feature from the condition, such as a type of deviation and a value of deviation. It is contemplated that the UAI message may include more/less information or parameters than illustrated in Table 13, without departing from the scope of the present disclosure. For instance, the UAI message may further include a performance metric associated with the AI/ML model, a training process associated with the AI/ML model, an inference accuracy associated with the AIML mode, information associated with data security mechanisms and privacy regulations, and the like.

According to example embodiments, the UE may be configured to perform the reactive reporting via Media Access Control (MAC) Control Element (CE) signaling. In this regard, the UE may be configured to include, in a MAC CE (or a message that includes the MAC CE), information associated with the AI/ML model applicability (may be referred to as “MAC CE AI/ML applicability query” or “MAC CE message” herein), thereby ensuring efficient and accurate applicability reporting. An example of the MAC CE message, according to one or more example embodiments, is presented in the following Table 14,

TABLE 14
Example MAC CE Message

```
MAC_CE_AIML_Applicability_Query {
  ai_ml_feature_id: INTEGER (1..1024),
  query_response_flag: ENUMERATED {query, response},
  applicability_result: ENUMERATED {applicable, not_applicable,
  unknown},
  evaluation_parameters: SEQUENCE {
    channel_conditions: INTEGER,
    mobility_status: ENUMERATED {stationary, moving, high_speed},
    battery_level: ENUMERATED {high, medium, low}
  }
}
```

Similar to the RRC message in Table 12, the MAC CE message in Table 14 may also include an ID associated with a feature of an AI/ML model (e.g., an integer between 1 to 1024, etc.), an applicability result (e.g., applicable, not applicable, unknown, etc.), and at least one evaluation parameter (e.g., channel condition, mobility status of the UE such as stationary, moving, and high speed, battery level of the UE such as high, medium, and low, etc.) In addition, the MAC CE message may include a flag associated with the applicability query message provided by the NE(s) and a response associated therewith. It is contemplated that the MAC CE message may include more/less information or parameters than illustrated in Table 14, without departing from the scope of the present disclosure. For instance, the MAC CE message may further include an applicability reason associated the applicability result, information associated with data security mechanisms and privacy regulations, and the like.

According to example embodiments, the UE may be configured to perform the reactive reporting via physical (PHY) layer signaling. In this regard, the UE may include the information associated with AI/ML model applicability into one or more PHY layer measurements (may be referred to as “PHY AI/ML applicability signaling” or “PHY layer message” herein), thereby enhancing the accuracy and reliability of applicability reporting. An example PHY layer message, according to one or more example embodiments, is presented in the following Table 15.

TABLE 15
Example PHY Layer Message

```
PHY_AIML_Applicability_Signaling {
  measurement_id: INTEGER (1..256),
  channel_conditions: INTEGER,
  mobility_status: ENUMERATED {stationary, moving, high_speed},
  beam_info: SEQUENCE {
    beam_id: INTEGER,
    beam_strength: INTEGER (0..100)
  }
}
```

As illustrated in Table 15, the PHY layer message may include an ID associated with the PHY layer measurement (e.g., an integer between 1 to 256, etc.), a parameter associated with the channel conditions (e.g., an integer, etc.), a mobility status of the UE (e.g., stationary, moving, high speed, etc.), and information associated with the beam of PHY layer signaling such as an ID of the beam (e.g., an integer, etc.) and a parameter associated with the strength of the beam (e.g., an integer between 0 to 100, etc.) It is contemplated that the PHY layer message may include more/less information or parameters than illustrated in Table 15, without departing from the scope of the present disclosure.

According to example embodiments, the UE may be configured to perform the reactive reporting via Non-Access Stratum (NAS) signaling. In this regard, the UE may be configured to receive, from the NE(s) via NAS signaling, a request for the AI/ML applicability information (may be referred to as “NAS AI/ML applicability request” or “NAS request message” herein), and then generates a response message including the requested applicability information (may be referred to as “NAS AI/ML applicability response”, “NAS response message”, or “NAS layer message” herein) and provide the same to the NE(s), thereby ensuring timely and accurate applicability reporting and supporting efficient network management. An example NAS AI/ML request message and an example NAS response message, according to one or more example embodiments, are presented in the following Table 16 and Table 17, respectively.

TABLE 16
Example NAS Request Message

```
NAS_AIML_Applicability_Request {
  ai_ml_feature_id: INTEGER (1..1024),
  query_parameters: SEQUENCE {
    condition_type: ENUMERATED {channel, mobility, battery,
    application},
    threshold_value: INTEGER
  }
}
```

As illustrated in Table 16, the NAS request message may include an ID associated with a feature of an AI/ML model (e.g., an integer between 1 to 1024, etc.) and a plurality of query parameters including a type of condition (e.g., channel, mobility, batter, application, etc.) and a threshold value to be utilized for evaluating the condition(s). It is contemplated that the NAS request message may include more/less information or parameters than illustrated in Table 16, without departing from the scope of the present disclosure.

TABLE 17
Example NAS Response Message

```
NAS_AIML_Applicability_Response {
  ai_ml_feature_id: INTEGER (1..1024),
  applicability_result: ENUMERATED {applicable, not_applicable,
  unknown},
  evaluation_parameters: SEQUENCE {
    channel_conditions: INTEGER,
    mobility_status: ENUMERATED {stationary, moving, high_speed},
    battery_level: ENUMERATED {high, medium, low}
  }
}
```

As illustrated in Table 17, similar to the RRC message in Table 12, the NAS response message may also include an ID associated with a feature of an AI/ML model (e.g., an integer between 1 to 1024, etc.), an applicability result (e.g., applicable, not applicable, unknown, etc.), and at least one evaluation parameter (e.g., channel condition, mobility status of the UE such as stationary, moving, and high speed, battery level of the UE such as high, medium, and low, etc.) It is contemplated that the NAS response message may include more/less information or parameters than illustrated in Table 17, without departing from the scope of the present disclosure.

In view of the above, by leveraging the applicability framework of the example embodiments, the UE and/or the NE(s) may be configured to perform proactive reporting, reactive reporting, or a combination thereof, thereby ensuring timely and accurate AI/ML applicability information exchange.

### Signaling Enhancement for Applicability Reporting

As described above, the UE and/or NE(s) may be configured to perform proactive reporting, reactive reporting, or a combination thereof, via RRC signaling, MAC CE signaling, and UAI signaling. In the following, further or alternative descriptions associated with these signaling and the associated messages are provided.

The following Table 18 illustrates an example RRC message.

TABLE 18
Example RRC Message

```
RRC_AIML_Applicability_Notification {
  ai_ml_feature_id: INTEGER (1..1024),
  applicabilityCondition: ApplicabilityCondition,
  applicabilityResult: ApplicabilityResult,
  applicabilityReason: ApplicabilityReason,
  actionSuggestion: ActionSuggestion,
}
```

The example RRC message in Table 18 may be utilized in proactive reporting, reactive reporting, or both the proactive reporting and reactive reporting, to ensure accurate and efficient communication of applicability information between the UE and the NE(s).

As illustrated in Table 18, the example RRC message may include: an ID associated with a feature of an AI/ML model (e.g., an integer between 1 to 1024, etc.), an applicability condition, an applicability result, an applicability reason, and an action suggestion. It is contemplated that the RRC message may include more/less information or parameters than illustrated in Table 18, without departing from the scope of the present disclosure. For instance, the RRC message may further include a parameter associated with a status of a UE, a parameter associated with a capability of the UE, and the like. Including these detailed descriptions of reporting metrics and parameters in the RRC message may ensure comprehensive and transparent communication of the UE's status and capabilities, as well as the information associated with AI/ML model applicability, to the network, thereby providing better insights and control.

As described above, the applicability condition may refer to the condition(s) under which an AI/ML model (or the associated feature) is applicable, such as channel conditions, UE speed, UE battery level, and the like. Providing detailed applicability condition(s) in the RRC message can ensure precise applicability reporting, which is essential for network optimization. An example structure of the applicability condition, according to one or more example embodiments, is presented in the following Table 19.

TABLE 19
Example Structure of Applicability Condition

```
ApplicabilityCondition {
  conditionId: INTEGER (1..256),
  conditionType: ENUMERATED {channel, mobility, battery,
  application},
  thresholdValue: INTEGER,
}
```

As illustrated in Table 19, the information associated with the applicability condition may include: an ID associated with an applicability condition (e.g., an integer between 1 to 256, etc.), a type of the applicability condition (e.g., channel, mobility, battery application, etc.), and a threshold value associated with the applicability condition (e.g., an integer).

On the other hand, the applicability result may refer to information indicating whether the AI/ML functionality is applicable, not applicable, unknown, or the like. Providing a clear applicability result in the RRC message can simplify network decision-making. An example structure of the applicability result, according to one or more example embodiments, is presented in the following Table 20.

TABLE 20
Example Structure of Applicability Result

ApplicabilityResult {
result: ENUMERATED {applicable, not_applicable, unknown},
}

Furthermore, the applicability reason may define the reason(s) or cause(s) that cause the applicability result, which may aid the NE(s) in network decision-making. Providing the applicability reason in the RRC message can enhance the transparency and traceability of applicability measurements. An example structure of the applicability reason, according to one or more example embodiments, is presented in the following Table 21.

TABLE 21
Example Structure of Applicability Reason

```
ApplicabilityReason {
  reasonId: INTEGER (1..256),
  reasonType: ENUMERATED {channel_conditions,
  mobility_status, battery_level,
application_requirements},
  details: STRING,
}
```

As illustrated in Table 21, the information associated with the applicability reason may include: an ID associated with the reason for the applicability result (e.g., an integer between 1 to 256, etc.), a type associated with the reason (e.g., channel condition, mobility status, battery level, application requirements, etc.), and details descriptions of the reason (e.g., a string description, etc.)

Further still, the action suggestion may include one or more suggestions on one or more actions that can (or shall) be taken based on the applicability result, the applicability reason, and/or the applicability condition. Providing the action suggestion in the RRC message can provide actionable insights, thereby enabling the NE(s) to dynamically optimize AI/ML functionalities. An example structure of the action suggestion, according to one or more example embodiments, is presented in the following Table 22.

TABLE 22
Example Structure of Action Suggestion

```
ActionSuggestion {
  actionId: INTEGER (1..256),
  actionType: ENUMERATED {activate, deactivate, update, retrain},
  reason: ApplicabilityReason,
}
```

As illustrated in Table 22, the information associated with the action suggestion may include: an ID associated with the suggested action(s) (e.g., an integer between 1 to 256, etc.), a type of the suggested action(s) (e.g., activate the AI/ML model, deactivate the AI/ML model, update the AI/ML model, retain the AI/ML model, etc.), and an applicability reason (e.g., one or more parameters or information presented in Table 21, etc.)

Next, descriptions of MAC CE for applicability reporting will be provided. According to example embodiments, the UE may perform the proactive reporting via MAC CE signaling. For instance, the UE may generate a MAC CE message during the proactive reporting (may be referred to as “Proactive MAC CE message” or “MAC CE proactive applicability report” herein). This MAC CE message may be designed to enable the UE to proactively report AI/ML applicability based on predefined conditions, thereby ensuring the network is always being informed about the AI/ML applicability status and enhancing responsiveness. An example Proactive MAC CE message, according to one or more example embodiments, is presented in the following Table 23.

TABLE 23
Example Proactive MAC CE Message

```
MAC_CE_Proactive_Applicability_Report {
  ai_ml_feature_id: INTEGER (1..1024),
  applicabilityCondition: ApplicabilityCondition,
  applicabilityResult: ApplicabilityResult,
  applicabilityReason: ApplicabilityReason,
}
```

As illustrated in Table 23, the Proactive MAC CE message may include: an ID associated with a feature of an AI/ML model (e.g., an integer between 1 to 1024, etc.), information associated with an applicability condition, information associated with an applicability result, and information associated with an applicability reasons. Said information has been described above with reference to Tables 19-21, thus redundant descriptions associated therewith may be omitted hereinbelow for conciseness.

According to example embodiments, the UE may perform the reactive reporting via MAC CE signaling. For instance, the UE may generate a MAC CE message during the reactive reporting (may be referred to as “Reactive MAC CE message” or “MAC CE reactive applicability report” herein). This MAC CE message may be designed to enable the UE to report AI/ML applicability in response to network queries, thereby allowing the network (or NE(s)) to request specific applicability information as needed and improving decision-making precision. An example reactive MAC CE message, according to one or more example embodiments, is presented in the following Table 24.

TABLE 24
Example Reactive MAC CE Message

```
MAC_CE_Reactive_Applicability_Response {
  ai_ml_feature_id: INTEGER (1..1024),
  applicabilityResult: ApplicabilityResult,
  applicabilityReason: ApplicabilityReason,
}
```

As illustrated in Table 24, the reactive MAC CE message may include: an ID associated with a feature of an AI/ML feature, information associated with an applicability result, and information associated with an applicability reason. Descriptions associated therewith have been provided above with reference to Tables 19-21 and 23, thus redundant descriptions associated therewith may be omitted hereinbelow for conciseness.

It is contemplated that the MAC CE message may include more/less information or parameters than illustrated in Tables 23-24, without departing from the scope of the present disclosure. For instance, in some example implementations, the MAC CE message may further include mechanisms designed to protect user data and ensure compliance with relevant privacy regulations. By including such information or parameters in the MAC CE message, potential privacy concerns may be addressed and data security in AI/ML applicability reporting may be enhanced, while ensuring compliance with relevant privacy regulations and protecting user data.

Next, descriptions of UAI signaling for applicability reporting will be provided. According to example embodiments, the UE may be configured to provide detailed information about AI/ML applicability (e.g., applicability conditions, real-time performance metrics, model statuses, etc.) to the NE(s) via UAI signaling.

For instance, the UE may generate a report message that includes the applicability information (may be referred to as “UAI message “UAI AI/ML applicability report” herein) and then provide the same to the NE(s), thereby providing granular UAI reporting in real-time (or near-real-time). An example UAI message, according to one or more example embodiments, is presented in the following Table 25.

TABLE 25
Example UAI Message

```
UAI_AIML_Applicability_Report {
  ai_ml_feature_id: INTEGER (1..1024),
  performanceMetrics: UAI_Performance_Metrics,
  trainingProgress: UAI_Training_Progress,
  inferenceAccuracy: UAI_Inference_Accuracy,
}
```

As illustrated in Table 25, the UAI message may include information associated with one or more performance metrics (presented as “UAI performance metrics”), information associated with the training progress of the AI/ML model (presented as “UAI training progress”), and information associated with an inference accuracy of the AI/ML model (“UAI inference accuracy”). It is contemplated that the UAI message may include more/less information or parameters than illustrated in Table 25, without departing from the scope of the present disclosure. For instance, in some example implementations, the UAI message may further include mechanisms designed to protect user data and ensure compliance with relevant privacy regulations. By including such information or parameters in the UAI message, potential privacy concerns may be addressed and data security in AI/ML applicability reporting may be enhanced, while ensuring compliance with relevant privacy regulations and protecting user data.

The performance metric(s) may define real-time (or near-real-time) performance associated with an AI/ML model, such as latency, accuracy, and power consumption. Including the performance metric(s) in the UAI message provides real-time (or near-real-time) insights into model performance, thereby enabling timely adjustment on the AI/ML model (if required). An example structure of the performance metric(s), according to one or more example embodiments, is presented in the following Table 26.

TABLE 26
Example Structure of Performance Metric

```
UAI_Performance_Metrics {
  metricId: INTEGER (1..256),
  metricType: ENUMERATED {latency, accuracy,
  power_consumption},
  metricValue: INTEGER,
}
```

As illustrated in Table 26, information associated with the performance metric may include: an ID associated with a performance metric (e.g., an integer between 1 to 256, etc.), a type of the performance metric (e.g., latency, accuracy, power consumption, etc.), and a value associated with the performance metric (e.g., an integer, etc.)

Further, the training progress of the AI/ML model may define the model readiness. Providing the training progress of the AI/ML model in the UAI message helps the NE(s) to understand the current capability of the AI/ML model. An example structure of the training progress, according to one or more example embodiments, is presented in the following Table 27.

TABLE 27
Example Structure of Training Progress

```
UAI_Training_Progress {
  ai_ml_feature_id: INTEGER (1..1024),
  progressPercentage: INTEGER (0..100),
}
```

As illustrated in Table 27, information associated with the training progress may include: an ID associated with a feature of an AI/ML model (e.g., an integer between 1 to 1024, etc.), and a percentage of the training progress (e.g., an integer between 0 to 100).

Furthermore, the inference accuracy of the AI/ML model may define the model performance. Providing the inference accuracy of the AI/ML model in the UAI message helps the NE(s) to determine the AI/ML model inference performance, which is critical for maintaining high service quality. An example structure of the inference accuracy, according to one or more example embodiments, is presented in the following Table 28.

TABLE 28
Example Structure of Inference Accuracy

```
UAI_Inference_Accuracy {
  ai_ml_feature_id: INTEGER (1..1024),
  accuracyPercentage: INTEGER (0..100),
}
```

As illustrated in Table 28, the information associated with the inference accuracy may include: an ID associated with a feature of an AI/ML model (e.g., an integer between 1 to 1024, etc.), and a percentage of the inference accuracy (e.g., an integer between 0 to 100).

### Dynamic Threshold Adjustment

According to example embodiments, the UE and/or the NE(s) may be configured to dynamically adjust a threshold associated with AI/ML model applicability based on real-time (or near-real-time) conditions, thereby ensuring optimal performance and applicability of AI/ML functionalities under varying network and environment condition(s) and enhancing the reliability and efficiency of AI/ML deployments in the network. An example algorithm of dynamic threshold adjustment, according to one or more example embodiments, is presented in the following Table 29.

TABLE 29
Example Algorithm of Dynamic Threshold Adjustment

```
Dynamic_Threshold_Adjustment {
  input: [network_load, UE_mobility, environmental_factors];
  output: adjusted_threshold;
  steps: [
    evaluate(network_load),
    assess(UE_mobility),
    analyze(environmental_factors),
    calculate(adjusted_threshold)
  ];
}
```

As illustrated in Table 29, the dynamic threshold adjustment includes inputting real-time (or near-real-time) condition(s) (e.g., network load, UE mobility, environmental factors, etc.), processing (e.g., evaluating, assessing, analyzing, etc.) the inputted condition(s) to calculate a new threshold (presented as “adjusted threshold” herein), and outputting the new threshold.

According to example embodiments, the UE and/or the NE(s) may be configured to adjust the threshold based on one or more parameters (may be referred to as “threshold adjustment parameter” herein) predefined by the network operator and/or the UE manufacturer, thereby ensuring that the threshold adjustment is precise and contextually relevant. Further, the use of context-specific parameters and regular adjustment interval(s) enable a level of granularity and responsiveness. An example structure associated with the threshold adjustment parameter, according to one or more example embodiments, is presented in the following Table 30.

TABLE 30
Example Structure of Threshold Adjustment Parameter

```
Threshold_Adjustment_Parameters {
  parameter_id: INTEGER (1..256),
  parameter_type: ENUMERATED {network_load, UE_mobility,
  environmental_factors},
  threshold_value: INTEGER,
  adjustment_interval: TIME,
}
```

As illustrated in Table 30, the threshold adjustment parameter may include: an ID associated with the threshold adjustment parameter(s) (e.g., an integer between 1 to 256 that is unique for each parameter), a parameter type (e.g., network load, UE mobility, environmental factors, etc.), a threshold value associated with the threshold adjustment parameter(s) (e.g., an integer, etc.), and an adjustment interval associated with a time interval for adjusting the threshold value.

According to example embodiments, upon adjusting the threshold(s), the UE and/or the NE(s) may be configured to report the adjusted threshold(s), thereby ensuring transparency and traceability of performance adjustments. For instance, the UE and/or the NE(s) may generate a report message that includes information associated with the adjusted threshold(s) (may be referred to as “adjusted threshold report” herein), and then provide the report message to the NE(s) and/or the UE, thereby ensuring that the adjustments are communicated and documented in real-time (or near-real-time) and allowing immediate analysis and further optimization if required. An example adjusted threshold report message, according to one or more example embodiments, is presented in the following Table 31.

TABLE 31
Example Adjusted Threshold Report

```
Adjusted_Threshold_Report {
  parameter_id: INTEGER (1..256),
  adjusted_threshold_value: INTEGER,
  timestamp: TIME,
}
```

As illustrated in Table 31, the adjusted threshold report may include: an ID associated with the threshold adjustment parameter(s) (e.g., an integer between 1 to 256 that is unique for each parameter), an adjusted threshold value which is the new threshold value after the adjustment, and a timestamp associated with the time when the threshold is adjusted.

### Real-Time Monitoring and Reporting

According to example embodiments, the UE and/or the NE(s) may be configured to monitor and report AI/ML-associated parameters, in real-time (or near-real-time). For instance, the UE and/or the NE(s) may continuously (or periodically) monitor and report one or more AI/ML performance metrics, thereby ensuring the reliability and accuracy of AI/ML functionalities and providing a proactive approach to maintain optimal AI/ML performance. Further, the real-time (or near-real-time) monitoring and reporting may facilitate immediate decision-making and adaptive responses to performance issues, thereby enhancing overall system resilience.

An example real-time monitoring procedure, according to one or more example embodiments, is presented in the following Table 32.

TABLE 32
Example Real-Time Monitoring Procedure

```
Real-time_Monitoring_Procedure {
  metrics: [latency, accuracy, power_consumption];
  frequency: TIME_INTERVAL;
  steps: [
    collect(latency),
    collect(accuracy),
    collect(power_consumption),
    log_data( ),
    report_data( )
  ];
}
```

As illustrated in Table 32, the real-time monitoring procedure may include a list of metrics to be monitored (e.g., latency, accuracy, power consumption, etc.), a frequency that defines a time interval for monitoring the metrics in the list, and the steps involved in the monitoring procedure (e.g., collecting metric(s), logging data, generating a report, etc.) An example of the report message that includes the real-time monitoring information or data (may be referred to as “real-time report message” herein), according to one or more example embodiments, is presented in the following Table 33.

TABLE 33
Example Real-Time Report Message

```
Real-time_Report_Message {
  metric_id: INTEGER (1..256),
  metric_value: INTEGER,
  timestamp: TIME,
}
```

As illustrated in Table 33, the real-time report message may include: an ID associated with a monitored performance metric (e.g., an integer between 1 to 256 that may be unique for each performance metric), a metric value that may include an integer associated with the monitored performance metric(s), and a timestamp associated with the time when the performance metric(s) is monitored and record.

### AI/ML Model Selection

In addition to determining and reporting the AI/ML model applicability, the applicability framework and mechanism of example embodiments may also be utilized to select one or more appropriate AI/ML models according to one or more conditions.

A non-limiting example use case for selecting multiple AI/ML models, according to one or more example embodiments, is presented in the following Table 34.

TABLE 34
Example Use Case

AI_ML_Applicability_Algorithm {
input: [

| | |
|---|---|
| UE_location_type, | // Locality: urban or rural |
| UE_speed, | // Speed: high-speed or low-speed |
| UE_storage, | // UE data storage capability |
| UE_processing_power, | // UE processing capability |
| UE_battery, | // UE battery level |
| network_congestion, | // Network congestion level |
| processing_load, | // OAM/Core Network processing load |
| user_privacy_settings, | // User privacy constraints |
| UE_model_version, | // UE model version |
| network_model_version, | // Network model version |
| time_of_day, | // Temporal factor: time of day |
| season, | // Temporal factor: season |
| environmental_conditions, | // Environmental factors |
| service_type, | // Service requirements: URLLC, eMBB, etc. |
| QoS_requirements, | // Quality of Service parameters |
| performance_metrics, | // Performance metrics for degradation check |
| dataset_size, | // Dataset characteristics: size |
| dataset_quality, | // Dataset characteristics: quality |
| dataset_bias, | // Dataset characteristics: bias |
| dataset_staleness | // Dataset characteristics: staleness |

```
  ];
  output: selected_model;
  steps: [
    // Step 1: Evaluate UE locality
    if (UE_location_type == urban) {
      selected_model = urban_model;
    } else {
      selected_model = rural_model;
    }
    // Step 2: Evaluate UE speed
    if (UE_speed > speed_threshold) {
      selected_model = high_speed_model;
    } else {
      selected_model = low_speed_model;
    }
    // Step 3: Assess UE capabilities
    if (UE_storage < storage_threshold ||
        UE_processing_power < processing_power_threshold ||
        UE_battery < battery_threshold) {
      selected_model = capability_optimized_model;
    }
    // Step 4: Check network conditions
    if (network_congestion > congestion_threshold ||
        processing_load > load_threshold) {
      selected_model = network_condition_optimized_model;
    }
    // Step 5: Consider user privacy constraints
    if (user_privacy_settings == privacy_restricted) {
      selected_model = privacy_preserving_model;
    }
    // Step 6: Evaluate model versions
    if (UE_model_version != network_model_version) {
      selected_model = compatible_model;
    }
    // Step 7: Factor in temporal and environmental conditions
    if (time_of_day == peak_hours ||
        season == winter ||
        environmental_conditions == severe) {
      selected_model = temporal_environmental_optimized_model;
    }
    // Step 8: Evaluate service requirements and QoS
    if (service_type == URLLC || QoS_requirements == high) {
      selected_model = URLLC_model;
    } else if (service_type == eMBB || QoS_requirements == medium) {
      selected_model = eMBB_model;
    }
    // Step 9: Check for model degradation over time
    if (performance_metrics indicate degradation) {
      selected_model = updated_model;
    }
    // Step 10: Assess dataset characteristics
    if (dataset_size < size_threshold ||
        dataset_quality < quality_threshold ||
        dataset_bias > bias_threshold ||
        dataset_staleness > staleness_threshold) {
      selected_model = dataset_optimized_model;
    }
  ];
```

As illustrated in Table 34, the AI/ML model selection procedure may include: inputting a plurality of applicability conditions, processing (e.g., evaluating, assessing, checking, etc.) each of the applicability conditions, and selecting an AI/ML model thereafter. Descriptions of each of the applicability conditions, as well as the operation or step for processing the applicability condition, are provided in the following.

As illustrated in Table 34, the applicability conditions may include: a location type of a UE (e.g., urban, rural, etc.), a speed of the UE (e.g., high speed, low speed, etc.), a capability of the UE (e.g., a storage capability of the UE, a processing capability of the UE, a battery level of the UE, etc.), a network condition (e.g., a congestion level of the network, a processing load of the network, etc.), a constraint on user privacy setting, a model version of the UE and a model version of the network, temporal factors like the time of day and the season, an environmental factor or condition, a service type or requirement (e.g., Ultra-Reliable Low Latency Communications (URLLC), enhanced Mobile Broadband (eMBB), etc.), a quality of service (QoS) requirement or parameter, a performance metric for performance degradation check, and dataset characteristics (e.g., dataset size, dataset quality, dataset bias, dataset staleness, etc.)

The AI/ML model applicability may depend on the location type of the UE. For example, a beamforming AI/ML model may differ for the UE in a dense urban location and in a less dense rural location. Accordingly, if the UE is in the rural location, a beamforming AI/ML model that is developed for the dense urban may not be applicable. Thus, in the example of Table 34, when the applicability condition includes the location type of the UE, the UE and/or the NE(s) may evaluate whether the location type is urban or rural, and then select an appropriate AI/MI model according to the location type of the UE, For instance, based on determining that the UE is in a rural location, the UE and/or the NE(s) may select an AI/ML model developed for the rural location, and vice versa.

In addition, the AI/ML model applicability may also depend on the speed of the UE. For example, a channel estimation AI/ML model may differ when the UE is at high speed and when the UE is at low speed. Thus, in the example of Table 34, when the applicability condition includes the speed of the UE, the UE and/or the NE(s) may evaluate whether or not the speed of the UE is greater than a predefined threshold (e.g., a threshold that indicates that the UE is in high speed/low speed), and then select an appropriate AI/ML model according to the speed of the UE. For instance, based on determining that the UE is in high speed, the UE and/or the NE(s) may select an AI/ML model developed for the high-speed UE, and vice versa.

Further, the AI/ML model applicability may also vary according to the capability of the UE, such as the storage capability associated with the available data storage in the UE, the processing capability of the UE such as the available computing power or processing unit, and the battery level of the UE that is associated with the power consumption of the UE, Thus, when the applicability condition includes one or more of these UE capabilities, the UE and/or the NE(s) may compare these UE capabilities to the associated thresholds, and then select an appropriate AI/ML model that is optimized according to the capability(s) of the UE.

Furthermore, the AI/ML model applicability may be affected by the network conditions, such as the congestion level of the network and the processing load of the network. Thus, when the applicability condition includes one or more of these network conditions, the UE and/or the NE(s) may compare these network conditions to the associated thresholds, and then select an appropriate AI/ML model that is optimized according to the network conditions.

In addition, the AI/ML model applicability may also depend on the privacy constraint on user privacy settings. For example, an AI/ML model that requires access to the user's location may not be applicable to users who have disabled location sharing in the privacy setting. Thus, when the applicability condition includes the user privacy setting, the UE and/or NE(s) may consider whether or not there is any constraint caused by the user privacy setting, and then select an appropriate AI/ML model based thereon. For instance, based on determining a constraint or restriction on user privacy settings, the UE and/or the NE(s) may select a privacy-preserving AI/ML model, and vice versa.

Further, the AI/ML model applicability may also depend on the model version of the UE and the network. For instance, the network may need to adjust the parameters of AI/ML models on the UEs to optimize their performance for different scenarios or conditions. Thus, when the applicability condition includes the model version of the UE and the network, the UE and/or NE(s) may evaluate the model versions to determine whether or not the UE model version is consistent with the network model version, and then select an appropriate AI/ML model based thereon. For instance, based on determining that the UE model version is not consistent with the network model version, the UE and/or the NE(s) may select an AI/ML model that is compatible with either the UE model version or the network model version.

Furthermore, the AI/ML model applicability may also depend on the factors in temporal and environmental conditions, such as the time of the day, the season of the day, traffic prediction, demand forecasting, weather prediction, and the like. Thus, when the applicability condition includes one or more temporal conditions and/or environmental conditions, the UE and/or NE(s) may evaluate these conditions and then select an AI/ML model that is optimized for the temporal conditions and/or the environmental conditions.

Further still, the AI/ML model applicability may also depend on service requirements or QoS requirements. For example, an AI/ML model developed for URLCC service may not be applicable to eMBB service. Thus, when the applicability condition includes one or more service requirements and/or QoS requirements, the UE and/or the NE(s) may determine the type of the service (e.g., URLLC, eMBB, etc.) and/or the QoS requirements (e.g., high, medium, low, etc.), and then select an appropriate AI/ML model based thereon.

In addition, the AI/ML model applicability may vary over time due to changes in the environment or in the user's need. For example, an AI/ML model for channel prediction may become less accurate as the channel conditions change. Thus, when the applicability condition includes one or more performance metrics, the UE and/or the NE(s) may check whether or not the performance metric(s) has degraded over time, and then select an appropriate AI/ML model based thereon. For instance, based on determining that the performance metric (s0 has degraded over time, the UE and/or the NE(s) may select an updated AI/ML model.

Further, the AI/ML model applicability may also depend on the dataset characteristics, such as the dataset size, the dataset quality, the dataset bias, and the dataset staleness. Thus, when the applicability condition includes one or more dataset characteristics, the UE and/or the NE(s) may assess the dataset characteristics by comparing the dataset characteristics to the associated thresholds, and then select an appropriate AI/ML model optimized for the dataset.

It is contemplated that the UE and/or the NE(s) may obtain any other suitable data (e.g., real-time data, etc.) and then select one or more AI/ML models based thereon, without departing from the scope of the present disclosure. Upon selecting the AI/ML model(s), the UE and/or the NE(s) may generate a report message that includes the information associated with the selected AI/ML model (e.g., ID of the selected model, name of the selected model, threshold(s) associated with the selected model, etc.), and then provide the report message to the NE(s) and/or the UE thereafter.

In view of the above, the example embodiments of the present disclosure provide frameworks and mechanisms for effectively and efficiently evaluating AI/ML model applicability, selecting appropriate AI/ML models, reporting AI/ML model applicability information, monitoring parameters/metrics associated with the AI/ML model applicability in real-time (or near-real-time), and dynamically adjusting thresholds associated with AI/ML model applicability.

It is contemplated that the example parameters and contents presented in above Tables 1-34 are merely examples of possible embodiments or use cases, and the scope of the present disclosure should not be limited thereto.

### Example Operations and Use Cases

In the following, example operations that implement one or more features of the applicability framework described above with reference to Tables 1-33, as well as example use cases associated therewith, are described.

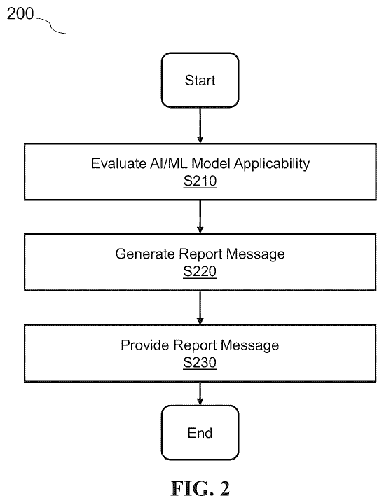

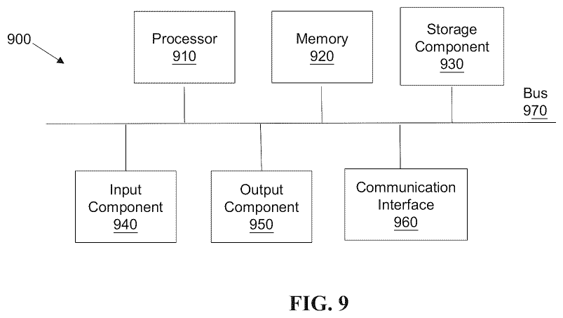

FIG. 2 illustrates a block diagram of an example method 200 for communicating AI/ML model applicability information, according to one or more example embodiments. One or more operations of method 200 may be performed by a device (e.g., a UE, a base station, etc.) to communicate the AI/ML model applicability to another device (e.g., a base station, a UE, etc.) For instance, the operation(s) may be performed by at least one processor of the device, upon executing computer-readable instructions stored in a memory storage of the device. Further descriptions of the processor and memory storage are provided below with reference to FIG. 9.

As illustrated in FIG. 2, at operation S210, the device may be configured to evaluate an applicability of an AI/ML model in relation to a mobile telecommunication network. According to example embodiments, the device may evaluate the AI/ML model applicability by comparing at least one applicability condition with a predefined threshold. The condition may include one or more of: a network condition (e.g., network load, channel condition, etc.), a mobility of the device (e.g., UE), and a battery level of the device (e.g., UE). Accordingly, based on determining that the applicability condition fulfills a condition defined by the predefined threshold (e.g., the battery level is higher than the predefined threshold indicates that the battery level fulfills a condition of “high battery level”, etc.), the device may determine that the AI/ML model is applicable. Otherwise, based on determining that the applicability condition does not fulfill the condition defined by the predefined threshold, the device may determine that the AI/ML model is not applicable.

According to example embodiments, the device may evaluate the AI/MI model applicability by determining whether the AI/ML model is configured correctly. For instance, the device may compare at least one applicability condition (e.g., a network condition, a mobility of a UE, a battery level of the UE, etc.) with an associated predefined threshold. Based on determining that the applicability condition fulfills a condition defined by the predefined threshold, the device may determine that the AI/ML model is configured correctly. Otherwise, based on determining that the applicability condition does not fulfill the condition defined by the predefined threshold, the device may determine that the AI/ML model is not configured correctly. Accordingly, based on determining that the AI/ML model is configured correctly, the device may determine that the AI/ML model is applicable. Conversely, based on determining that the AI/ML model is not configured correctly, the device may determine that the AI/ML model is not applicable. In this way, the device may assess the availability and readiness of the AI/ML model, while ensuring that the AI/ML model is configured correctly and free from internal issues. Ultimately, the reliability of functionality applicability may be enhanced.

Subsequently, at operation S220, the device may be configured to generate a report message that includes the evaluated applicability. According to example embodiments, the report message may include at least one of: an RRC message, a UAI message, a MAC CEW message, a PHY layer message, and a NAS layer message.

According to example embodiments where the report message includes the RRC message, the RRC message may include at least one of: an applicability condition under which the AI/ML model is applicable, an applicability result that indicates whether a feature of the AI/ML model is applicable, an applicability reason associated with a reason of the applicability result, an action suggestion associated with an action the at least one NE should take based on the applicability result, a parameter associated with a status of a UE, and a parameter associated with a capability of the UE.

According to example embodiments where the report message includes the MAC CE message, the MAC CE message may include at least one of: an ID associated with a feature of the AI/ML model, an applicability result that indicates whether the feature of the AI/ML model is applicable, an applicability reason associated with a reason of the applicability result, and mechanisms (or information associated therewith) designed to protect user data and ensure compliance with relevant privacy regulations.

According to example embodiments where the report message includes the UAI message, the UAI message may include at least one of: an ID associated with a feature of the AI/ML model, an applicability result that indicates whether the feature of the AI/ML model is applicable, an applicability reason associated with a reason of the applicability result, and mechanisms (or information associated therewith) designed to protect user data and ensure compliance with relevant privacy regulations.

Subsequently, at operation S230, the device may be configured to provide the report message to at least one NE of the mobile telecommunication network. For instance, the device may provide the report message to the at least one NE via RRC signaling, UAI signaling, MAC CE signaling, PHY layer signaling, and NAS layer signaling.

Further descriptions associated with the evaluation of AI/ML model applicability, the generation of the report message, and the communication of the report message, as well as each type of the report message and the example contents thereof, have been provided above with reference to at least a portion of the Tables 1-34. Thus, redundant descriptions associated therewith may be omitted hereinbelow for conciseness.

According to example embodiments, the device may be configured to autonomously perform the evaluation of the AI/ML model applicability, the generation of the reporting message, and the providing of the report message, based on a triggering condition. In some example implementations, the triggering condition may include a predefined activation condition associated with a functionality of at least one of: the device and the NE, An example use case associated therewith is described in the following.

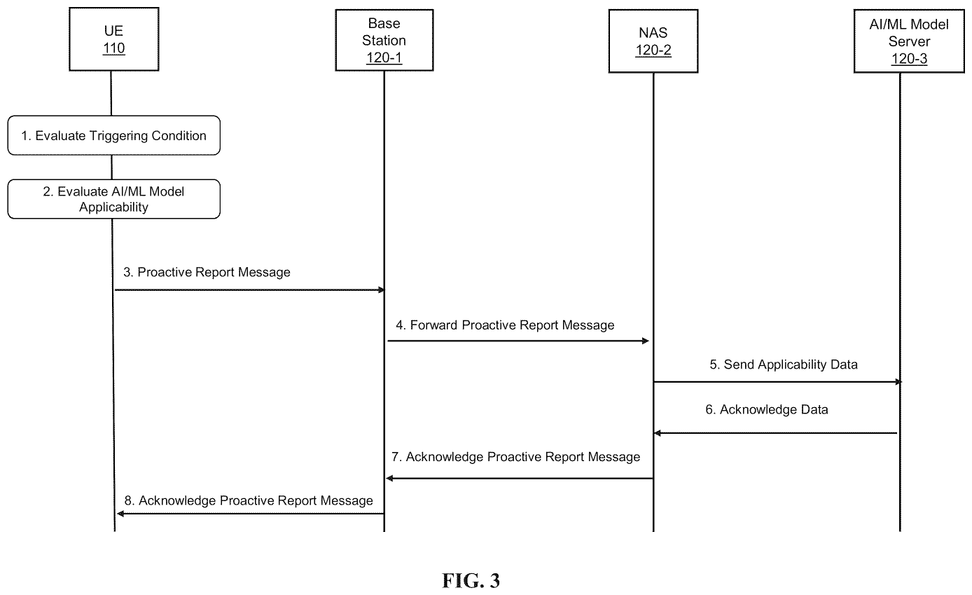

FIG. 3 illustrates a flow diagram of an example use case associated with proactive reporting, according to one or more example embodiments. This example use case may involve one or more operations of method 200 in FIG. 2. Further, merely for descriptive purposes, it is assumed that in this use case, the UE 110 has received one or more triggering conditions from at least one NE (e.g., the base station 120-1, etc.).

As illustrated in FIG. 3, at step 1, the UE 110 may evaluate at least one triggering condition to determine whether or not the evaluation of AI/ML model applicability should be triggered (e.g., whether or not a desired condition is fulfilled, whether or not a desired AI/ML is configured correctly, etc.) Accordingly, based on determining that the evaluation of AI/ML model applicability should be triggered, at step 2, the UE 110 may evaluate or determine the AI/ML model applicability. Subsequently, at step 3, the UE 110 may generate a report message and send the report message to the base station 120-1 (e.g., via RRC signaling, UAI signaling, etc.)

Upon receiving the proactive report message from the UE 110, at step 4, the base station 120-1 may forward the proactive report message to the NAS 120-2. Subsequently, at step 5, the NAS 120-2 may send data associated with the AI/ML model applicability to the AI/ML model server 120-3. Next, at step 6, the AI/ML model server 120-3 may provide a response message to the NSA 120-2 to acknowledge the receipt of the data. Accordingly, at step 7, the NAS 120-2 may provide a response message to the base station 120-1 to acknowledge the receipt of the proactive report message. Similarly, at step 8, the base station 120-1 may provide a response message to the UE 110 to acknowledge the receipt of the proactive report message.

In view of the above, the UE 110 may automatically initiate the AI/ML model applicability evaluation procedure and report the AI/ML model applicability to the NEs (e.g., base station 120-1, NAS 120-2, AI/ML model server 120-3). Further descriptions associated with the procedures and messages involved therein have been provided above with reference to the “proactive reporting” mechanism, thus redundant descriptions may be omitted hereinbelow for conciseness.

According to example embodiments, the device may be configured to perform the evaluation of the AI/ML model applicability, the generation of the reporting message, and the providing of the report message, in response to receiving a query message from the at least one NE. In some example implementations, the query message may include information associated with at least one of: a network configuration and a network condition.

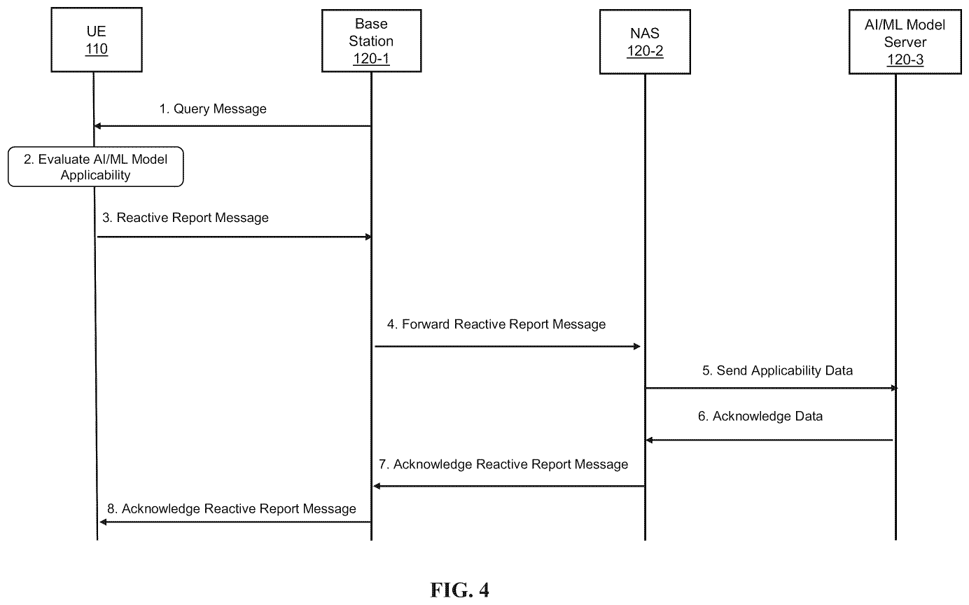

FIG. 4 illustrates a flow diagram of an example use case associated with reactive reporting, according to one or more example embodiments. This example use case may involve one or more operations of method 200 in FIG. 2. Further, one or more steps in the example use case of FIG. 4 may be similar to one or more steps in the example use case of FIG. 3. An example use case associated therewith is described in the following.

As illustrated in FIG. 4, at step 1, the base station 120-1 may provide a query message (e.g., via RRC signaling, etc.) to the UE 110. Accordingly, the UE 110 may evaluate the AI/ML model applicability (at step 2) and send a reactive report message to the base station 120-1 (at step 3).

In this regard, steps 2-8 in FIG. 4 may be similar to steps 2-8 in FIG. 3. These steps may be different from those in the example use case of FIG. 3 in that the UE 110 may be configured to generate and send a reactive report message (instead of a proactive report message) to the NEs. Further, steps 2-8 in FIG. 4 are triggered in response to receiving a query message, instead of automatically initiated based on the evaluation of triggering condition(s) as illustrated in FIG. 3.

In view of the above, the UE 110 may initiate the AI/ML model applicability evaluation procedure and report the AI/ML model applicability to the NEs (e.g., base station 120-1, NAS 120-2, AI/ML model server 120-3), in response to receiving a query message from the base station 120-1. Further descriptions associated with the procedures and messages involved therein have been provided above with reference to the “reactive reporting” mechanism, thus redundant descriptions may be omitted hereinbelow for conciseness.

According to example embodiments, the device may be configured to dynamically adjust at least one predefined threshold associated with AI/ML model applicability based on real-time (or near-real-time) data. For instance, the device may adjust a predefined threshold associated with a triggering condition (e.g., a predefined threshold for evaluating the triggering condition). Additionally or alternatively, the device may adjust a predefined threshold associated with an applicability condition (e.g., a predefined threshold for evaluating the AI/ML model applicability).

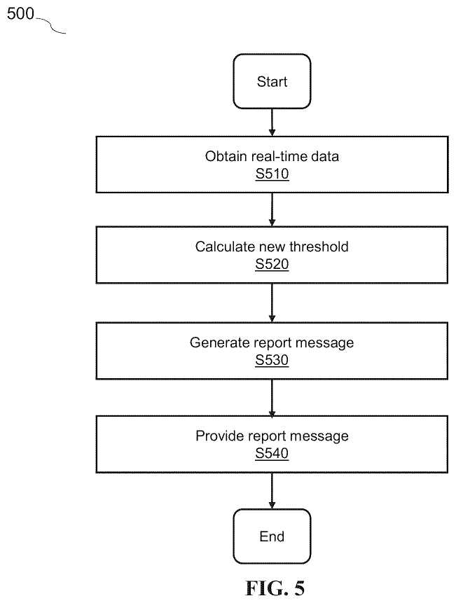

FIG. 5 illustrates a block diagram of an example method 500 for dynamic threshold reporting, according to one or more example embodiments. One or more operations of method 500 may be performed by the device (e.g., UE, base station, etc.) Further, one or more operations of method 500 may be performed independently/dependent on method 200 in FIG. 2. Furthermore, merely for descriptive purposes, it may be assumed that the method 500 may be performed for adjusting a predefined threshold associated with an applicability condition.

As illustrated in FIG. 5, at operation S510, the device may be configured to obtain a real-time data. In this regard, the real-time data may include at least one of: a current network condition (e.g., network load, network congestion level, etc.), a current UE mobility (e.g., static, high-speed movement, low-speed movement, etc.), and an environmental factor (e.g., season, etc.)

Subsequently, at operation S520, the device may be configured to calculate a new threshold for the applicability condition, based on the obtained real-time data. Next, at operation S530, the device may be configured to generate a report message that includes information associated with the new threshold. Accordingly, at operation S540, the device may be configured to provide the report message.

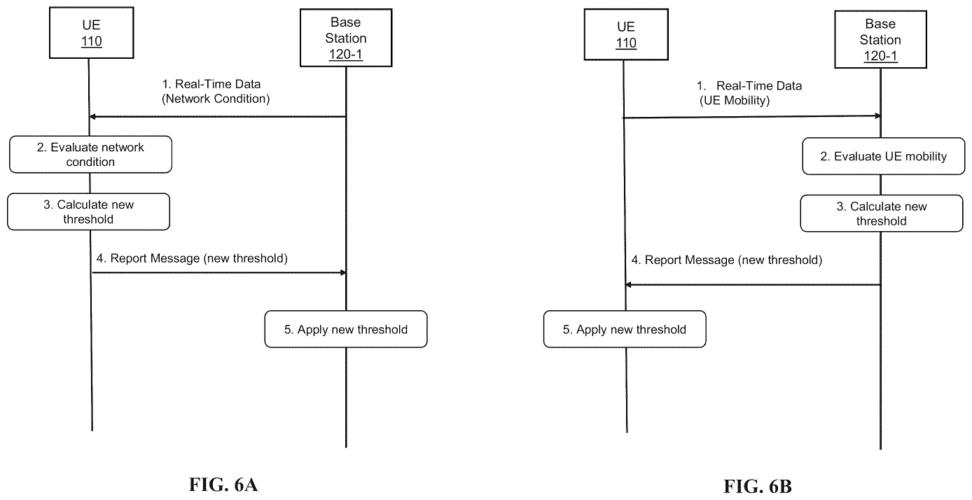

FIG. 6A and FIG. 6B each illustrates a flow diagram of an example use case associated with dynamic threshold adjustment, according to one or more example embodiments. These example use cases may involve one or more operations of method 500 in FIG. 5.

Referring first to FIG. 6A, which is associated with an example use case where the calculation of the new threshold is calculated by the UE 110 while the new threshold is applied/adjusted by the base station 120-1.

As illustrated in FIG. 6A, at step 1, the UE 110 may be configured to obtain data of real-time (or near-real-time) network conditions from the base station 120-1. Accordingly, at step 2, the UE 110 may evaluate the network conditions, and at step 3, the UE 110 may calculate a new threshold. Subsequently, at step 4, the UE 110 may provide, to the base station 120-1, a report message that includes information associated with the new threshold. Accordingly, at step 5, the base station 120-1 may adjust or modify the predefined threshold to apply the new threshold. Referring next to FIG. 6B, which is associated with an example use case where the [0162] calculation of the new threshold is calculated by the based station 120-1 while the new threshold is applied/adjusted by the UE 110.

As illustrated in FIG. 6B, at step 1, the base station 120-1 may be configured to obtain data of real-time (or near-real-time) UE mobility from the UE 110. Accordingly, at step 2, the base station 120-1 may evaluate the UE mobility, and at step 3, the base station 120-1 may calculate a new threshold. Subsequently, at step 4, the base station 120-1 may provide, to the UE 110, a report message that includes information associated with the new threshold. Accordingly, at step 5, the UE 110 may adjust or modify the predefined threshold to apply the new threshold.

In view of the above, the device may dynamically adjust thresholds associated with the AI/ML model applicability based on real-time (or near-real-time) data. Further descriptions associated with the procedures and messages involved therein have been provided above with reference to at least a portion of Tables 1-34, thus redundant descriptions may be omitted hereinbelow for conciseness.

According to example embodiments, the device may be configured to perform real-time monitoring and reporting of performance metrics associated with the AI/ML model applicability.

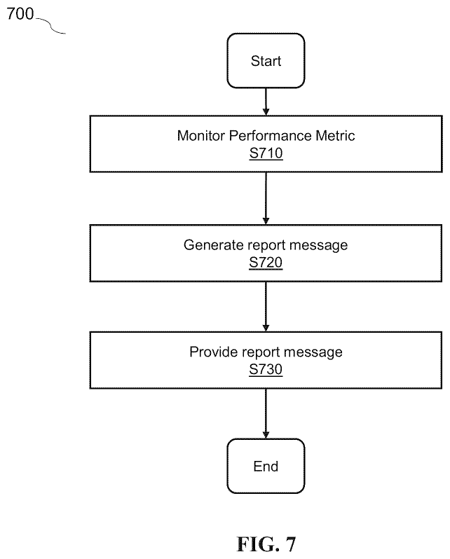

FIG. 7 illustrates a block diagram of an example method 700 for real-time monitoring and reporting, according to one or more example embodiments. One or more operations of method 700 may be performed by the device (e.g., UE, base station, etc.) Further, one or more operations of method 700 may be performed independently/dependent on the method 200 in FIG. 2 and/or the method 500 in FIG. 5.

As illustrated in FIG. 7, at operation S710, the device may be configured to monitor at least one performance metric of an AI/ML model. The performance metric may include, for example, latency, accuracy, power consumption, and the like.

Subsequently, at operation S720, the device may be configured to generate a report message that includes at least one of: an ID associated with the monitored performance metric, a metric value associated with the monitored performance metric, and a timestamp associated with a time when the performance metric is monitored. Accordingly, at operation S730, the device may be configured to provide the report message.

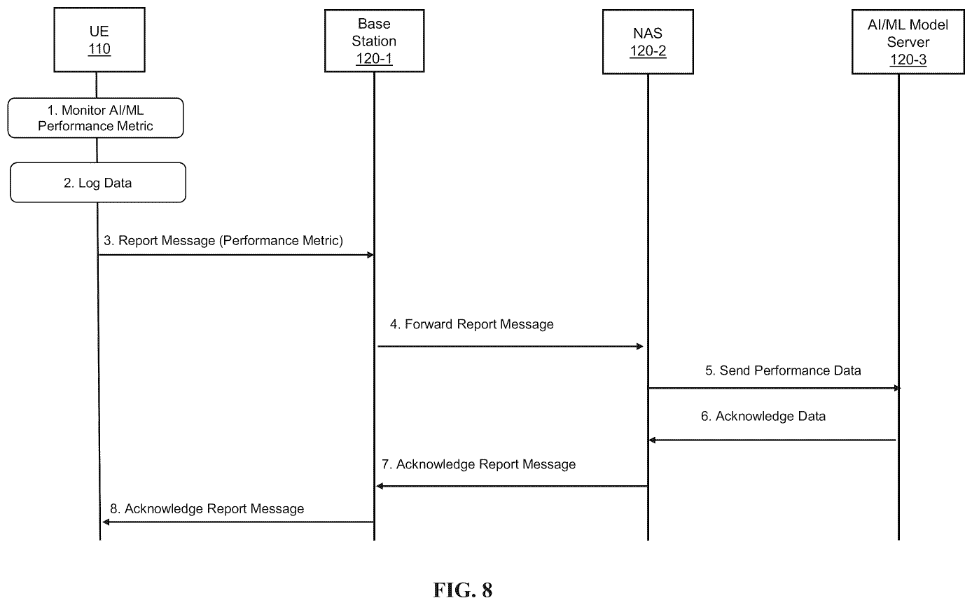

FIG. 8 illustrates a flow diagram of an example use case associated with real-time monitoring and reporting, according to one or more example embodiments. This example use case may involve one or more operations of method 700 in FIG. 7.

As illustrated in FIG. 8, at step 1, the UE 110 may monitor at least one performance metric of an AI/ML model. Subsequently, at step 2, the UE 110 may record or log data associated with the monitored performance metric. Next, at step 3, the UE 110 may generate a report message that includes information associated with the monitored performance metric and then provide the report message to the base station 120-1.

Accordingly, at step 4, the base station 120-1 may forward the report message to the NAS 120-2. Further, at step 5, the NAS 120-2 may send data associated with the performance of the AI/ML model to the AI/ML model server 120-3. Subsequently, at step 6, the AI/ML model server 120-3 may provide a response message to the NSA 120-2 to acknowledge the receipt of the performance data. Accordingly, at step 7, the NAS 120-2 may provide a response message to the base station 120-1 to acknowledge the receipt of the report message. Similarly, at step 8, the base station 120-1 may provide a response message to the UE 110 to acknowledge the receipt of the report message.

In view of the above, the UE 110 may monitor the real-time performance metrics of the AI/ML model and report the same to the NEs (e.g., base station 120-1, NAS 120-2, AI/ML model server 120-3). Further descriptions associated with the procedures and messages involved therein have been provided above with reference to at least a portion of Tables 1-34, thus redundant descriptions may be omitted hereinbelow for conciseness.

According to example embodiments, the device may be configured to select one or more AI/MI models. For instance, the device may obtain a real-time data (e.g., a current network condition, a current UE capability, an environmental factor, etc.) and then select an AI/ML model based thereon (e.g., select an AI/ML model that is configured correctly and free from internal issues, select an AI/ML mode that optimized for the current network condition/current UE capability, etc.) Upon selecting the AI/ML model, the device may generate a report message that includes information associated with the selected AI/MI model, and then provide the report message (e.g., to a UE, to an NE, etc.)

In view of the above, the device may select an appropriate AI/ML model based on real-time and dynamic conditions, and then report the same to other network components. Further descriptions associated with the procedures and messages involved therein have been provided above with reference to at least a portion of Tables 1-34, thus redundant descriptions may be omitted hereinbelow for conciseness.

### Examples of Hardware Components

One or more components of the system of the example embodiments (e.g., UE, base station, etc.), as well as the operations associated therewith, may be implemented in one or more devices or hardware components. For instance, one or more components/operations of the base station may be implemented in one or more servers, and the like.

In the following, descriptions of a device in which the example embodiments may be implemented are provided. It is contemplated that one or more features, operations, and methods described above with reference to FIG. 1 to FIG. 8 may be performed by the device. For instance, the one or more operations or methods may be performed by at least one processor of the device upon executing machine-readable instructions or computer-readable instructions stored in a memory or a storage component of the device.

FIG. 9 illustrates an embodiment of a device 900. As shown in FIG. 9, the device 900 may include a processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single core processor, or a combination of one or more multi-core processors and/or one or more single core processors, a distributed processing system, or the like. The processor 910 may be a Central Processing Unit (CPU), a graphics processing unit (GPU), an accelerated processing unit (APU), an application-specific integrated circuit (ASIC), or another type of processing component.

Memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 cause the processor 910 to perform one or more method steps of an embodiment described above.

Storage component 930 stores information and/or software related to the operation and use of the device 900. For example, storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touch screen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the device 900. For example, the output component 950 may be, but not limited to, a display, a speaker, instructions to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the device 900 and other devices. In other words, the standard of the communication interface 960 is not limited.

The bus 970 acts as an interconnect between the processor 910, the memory 920, the storage component 930, the input component 940, the output component 950, and the communication interface 960 of the device 900. The bus 970 may include a wired interconnection or a wireless interconnection.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of devices 900 in communication with one another.

### Various Aspects of Embodiments

It is contemplated that the example embodiments described hereinabove with reference to FIG. 1 to FIG. 9 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed, Modifications and variations are possible in light of the above disclosure or may be acquired from practice of the implementations.

Some embodiments may relate to a device (e.g., network node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server, In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A device configured to: evaluate an applicability of an Artificial Intelligent (AI)/Machine Learning (ML) model in relation to a mobile telecommunication network; generate a report message that includes the evaluated applicability; and provide the report message to at least one Network Element (NE) of the mobile telecommunication network.

Item [2]: The device according to item [1], wherein the device may be configured to autonomously perform the evaluation of the AI/ML model applicability, the generation of the reporting message, and the providing of the report message, based on a triggering condition, and wherein the triggering condition may include a predefined activation condition associated with a functionality of at least one of: the device and the NE.

Item [3]: The device according to any one of items [1]-[2], wherein the device may be configured to perform the evaluation of the AI/ML model applicability, the generation of the reporting message, and the providing of the report message, in response to receiving a query message from the at least one NE, and wherein the query message may include information associated with at least one of: a network configuration and a network condition.

Item [4]: The device according to any one of items [1]-[3], wherein the report message may include at least one of: a Radio Resource Control (RRC) message, a User Equipment (UE) Assistance Information (UAI) message, a Medium Access Control (MAC) Control Element (CE) message, a Physical (PHY) layer message, and a Non-Access Stratum (NAS) layer message.

Item [5]: The device according to item [4], wherein the report message may include the RRC message, and the RRC message may include at least one of: an applicability condition under which the AI/ML model is applicable, an applicability result that indicates whether a feature of the AI/ML model is applicable, an applicability reason associated with a reason of the applicability result, an action suggestion associated with an action the at least one NE should take based on the applicability result, a parameter associated with a status of a UE, and a parameter associated with a capability of the UE.

Item [6]; The device according to item [4], wherein the report message may include the MAC CE message, and the MAC CE message may include at least one of: an identifier (ID) associated with a feature of the AI/ML model, an applicability result that indicates whether the feature of the AI/ML model is applicable, and an applicability reason associated with a reason of the applicability result.

Item [7]: The device according to item [4], wherein the report message may include the UAI message, wherein the UAI message may include at least one of: an identifier (ID) associated with a feature of the AI/ML model, a performance metric associated with the AI/ML model, a training progress associated with the AI/ML model, and an inference accuracy associated with the AI/ML model.

Item [8]: The device according to any one of items [1]-[7], wherein the device may be configured to evaluate the applicability by: determining whether the AI/ML model is configured correctly; based on determining that the AI/ML model is configured correctly, determining that the AI/ML model is applicable; and based on determining that the AI/ML model is not configured correctly, determining that the AI/ML model is not applicable.

Item [9]: The device according to item [8], wherein the device may be configured to determine whether the AI/ML model is configured correctly by: comparing an applicability condition with a predefined threshold, wherein the applicability condition may include at least one of: a network condition, a mobility of a UE, and a battery level of the UE; based on determining that the applicability condition fulfills a condition defined by the predefined threshold, determining that the AI/ML model is configured correctly; and based on determining that the applicability condition does not fulfill the condition defined by the predefined threshold, determining that the AI/ML model is not configured correctly.

Item [10]: The device according to item [9], wherein the device may be further configured to: obtain a real-time data, wherein the real-time data may include at least one of: a current network condition, a current UE mobility, and an environmental factor; calculate, based on the real-time data, a new threshold for the applicability condition; generate a second report message that comprises the new threshold; and provide, to the at least one NE, the second report message.

Item [11]: The device according to any one of items [1]-[10], wherein the device may be further configured to: monitor a performance metric of the AI/ML model; generate a third report message that may include at least one of: an ID associated with the monitored performance metric, a metric value associated with the monitored performance metric, and a timestamp associated with a time when the performance metric is monitored; and provide, to the at least one NE, the third report message.

Item [12]: The device according to any one of items [1]-[11], wherein the device may be further configured to: obtain a real-time data, wherein the real-time data may include at least one of: a current network condition, a current UE capability, and an environmental factor; select, based on the real-time data, an AI/ML model; generate a fourth report message that may include information associated with the selected AI/MI model; and provide, to the at least one NE, the fourth report message.

Item [13]: A method including: evaluating an applicability of an Artificial Intelligent (AI)/Machine Learning (ML) model in relation to a mobile telecommunication network; generating a report message that includes the evaluated applicability; and providing the report message to at least one Network Element (NE) of the mobile telecommunication network.

Item [14]: The method according to item [13], wherein the method may include: automatically performing the evaluation of the AI/ML model applicability, the generation of the report message, and the providing of the report message, based on a triggering condition, and wherein the triggering condition may include a predefined activation condition associated with a functionality of at least one of: a UE and the NE.

Item [15]: The method according to any one of items [13]-[14], wherein the method may include: performing the evaluation of the AI/ML model applicability, the generation of the report message, and the providing of the report message, in response to receiving a query message from the at least one NE, and wherein the query message may include information associated with at least one of: a network configuration and a network condition.

Item [16]: The method according to any one of items [13]-[15], wherein the evaluating the applicability may include: determining whether the AI/ML model is configured correctly; based on determining that the AI/ML model is configured correctly, determining that the AI/ML model is applicable; and based on determining that the AI/ML model is not configured correctly, determining that the AI/ML model is not applicable. The determining whether the AI/ML model is configured correctly may include: comparing an applicability condition with a predefined threshold, wherein the applicability condition may include at least one of; a network condition, a mobility of a UE, and a battery level of the UE; based on determining that the applicability condition fulfills a condition defined by the predefined threshold, determining that the AI/ML model is configured correctly; and based on determining that the applicability condition does not fulfill the condition defined by the predefined threshold, determining that the AI/ML model is not configured correctly.

Item [17]: The method according to item [16], wherein the method may further include: obtaining a real-time data, wherein the real-time data comprises at least one of: a current network condition, a current UE mobility, and an environmental factor; calculating, based on the real-time data, a new threshold for the applicability condition; generating a second report message that comprises the new threshold; and providing, to the at least one NE, the second report message.

Item [18]: The method according to any one of items [13]-[17], wherein the method may further include: monitoring a performance metric of the AI/ML model; generating a third report message that comprises an ID associated with the monitored performance metric, a metric value associated with the monitored performance metric, and a timestamp associated with a time when the performance metric is monitored; and providing, to the at least one NE, the third report message.

Item [19]: The method according to any one of items [13]-[18], wherein the method may further include: obtaining a real-time data, wherein the real-time data may include at least one of: a current network condition, a current UE capability, and an environmental factor; selecting, based on the real-time data, an AI/ML model; generating a fourth report message that may include information associated with the selected AI/MI model; and providing, to the at least one NE, the fourth report message.

Item [20]: A non-transitory computer-readable recording medium that may have recorded thereon instructions executable by a device to cause the device to perform a method including: evaluating an applicability of an Artificial Intelligent (AI)/Machine Learning (ML) model in relation to a mobile telecommunication network; generating a report message that includes the evaluated applicability; and providing the report message to at least one Network Element (NE) of the mobile telecommunication network.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A device configured to:
evaluate an applicability of an Artificial Intelligent (AI)/Machine Learning (ML) model in relation to a mobile telecommunication network;
generate a report message that includes the evaluated applicability; and
provide the report message to at least one Network Element (NE) of the mobile telecommunication network.

2. The device according to claim 1,
wherein the device is configured to autonomously perform the evaluation of the AI/ML model applicability, the generation of the reporting message, and the providing of the report message, based on a triggering condition, and
wherein the triggering condition comprises a predefined activation condition associated with a functionality of at least one of: the device and the NE.

3. The device according to claim 1,
wherein the device is configured to perform the evaluation of the AI/ML model applicability, the generation of the reporting message, and the providing of the report message, in response to receiving a query message from the at least one NE, and
wherein the query message comprises information associated with at least one of: a network configuration and a network condition.

4. The device according to claim 1, wherein the report message comprises at least one of: a Radio Resource Control (RRC) message, a User Equipment (UE) Assistance Information (UAI) message, a Medium Access Control (MAC) Control Element (CE) message, a Physical (PHY) layer message, and a Non-Access Stratum (NAS) layer message.

5. The device according to claim 4, wherein the report message comprises the RRC message, and the RRC message comprises at least one of: an applicability condition under which the AI/ML model is applicable, an applicability result that indicates whether a feature of the AI/ML model is applicable, an applicability reason associated with a reason of the applicability result, an action suggestion associated with an action the at least one NE should take based on the applicability result, a parameter associated with a status of a UE, and a parameter associated with a capability of the UE.

6. The device according to claim 4, wherein the report message comprises the MAC CE message, and the MAC CE message comprises at least one of: an identifier (ID) associated with a feature of the AI/ML model, an applicability result that indicates whether the feature of the AI/ML model is applicable, and an applicability reason associated with a reason of the applicability result.

7. The device according to claim 4, wherein the report message comprises the UAI message, wherein the UAI message comprises at least one of: an identifier (ID) associated with a feature of the AI/ML model, a performance metric associated with the AI/ML model, a training progress associated with the AI/ML model, and an inference accuracy associated with the AI/ML model.

8. The device according to claim 1, wherein the device is configured to evaluate the applicability by:
determining whether the AI/ML model is configured correctly;
based on determining that the AI/ML model is configured correctly, determining that the AI/ML model is applicable; and
based on determining that the AI/ML model is not configured correctly, determining that the AI/ML model is not applicable.

9. The device according to claim 8, wherein the device is configured to determine whether the AI/ML model is configured correctly by:
comparing an applicability condition with a predefined threshold, wherein the applicability condition comprises at least one of: a network condition, a mobility of a UE, and a battery level of the UE;
based on determining that the applicability condition fulfills a condition defined by the predefined threshold, determining that the AI/ML model is configured correctly; and
based on determining that the applicability condition does not fulfill the condition defined by the predefined threshold, determining that the AI/ML model is not configured correctly.

10. The device according to claim 9, wherein the device is further configured to:
obtain a real-time data, wherein the real-time data comprises at least one of: a current network condition, a current UE mobility, and an environmental factor;
calculate, based on the real-time data, a new threshold for the applicability condition;
generate a second report message that comprises the new threshold; and
provide, to the at least one NE, the second report message.

11. The device according to claim 1, wherein the device is further configured to:
monitor a performance metric of the AI/ML model;
generate a third report message that comprises an ID associated with the monitored performance metric, a metric value associated with the monitored performance metric, and a timestamp associated with a time when the performance metric is monitored; and
provide, to the at least one NE, the third report message.

12. The device according to claim 1, wherein the device is further configured to:
obtain a real-time data, wherein the real-time data comprises at least one of: a current network condition, a current UE capability, and an environmental factor;
select, based on the real-time data, an AI/ML model;
generate a fourth report message that comprises information associated with the selected AI/MI model; and
provide, to the at least one NE, the fourth report message.

13. A method comprising:
evaluating an applicability of an Artificial Intelligent (AI)/Machine Learning (ML) model in relation to a mobile telecommunication network;
generating a report message that includes the evaluated applicability; and
providing the report message to at least one Network Element (NE) of the mobile telecommunication network.

14. The method according to claim 13, wherein the method comprises:
automatically performing the evaluation of the AI/ML model applicability, the generation of the report message, and the providing of the report message, based on a triggering condition, and
wherein the triggering condition comprises a predefined activation condition associated with a functionality of at least one of: a device and the NE.

15. The method according to claim 13, wherein the method comprises:
performing the evaluation of the AI/ML model applicability, the generation of the report message, and the providing of the report message, in response to receiving a query message from the at least one NE, and
wherein the query message comprises information associated with at least one of: a network configuration and a network condition.

16. The method according to claim 13,
wherein the evaluating the applicability comprises:
determining whether the AI/ML model is configured correctly;
based on determining that the AI/ML model is configured correctly, determining that the AI/ML model is applicable; and
based on determining that the AI/ML model is not configured correctly, determining that the AI/ML model is not applicable,
wherein the determining whether the AI/ML model is configured correctly comprises:
comparing an applicability condition with a predefined threshold, wherein the applicability condition comprises at least one of: a network condition, a mobility of a UE, and a battery level of the UE;
based on determining that the applicability condition fulfills a condition defined by the predefined threshold, determining that the AI/ML model is configured correctly; and
based on determining that the applicability condition does not fulfill the condition defined by the predefined threshold, determining that the AI/ML model is not configured correctly.

17. The method according to claim 16, wherein the method further comprises:
obtaining a real-time data, wherein the real-time data comprises at least one of: a current network condition, a current UE mobility, and an environmental factor;
calculating, based on the real-time data, a new threshold for the applicability condition;
generating a second report message that comprises the new threshold; and
providing, to the at least one NE, the second report message.

18. The method according to claim 13, wherein the method further comprises:
monitoring a performance metric of the AI/ML model;
generating a third report message that comprises an ID associated with the monitored performance metric, a metric value associated with the monitored performance metric, and a timestamp associated with a time when the performance metric is monitored; and
providing, to the at least one NE, the third report message.

19. The method according to claim 13, wherein the method further comprises:
obtaining a real-time data, wherein the real-time data comprises at least one of: a current network condition, a current UE capability, and an environmental factor;
selecting, based on the real-time data, an AI/ML model;
generating a fourth report message that comprises information associated with the selected AI/MI model; and
providing, to the at least one NE, the fourth report message.

20. A non-transitory computer-readable recording medium having recorded thereon instructions executable by a device to cause the device to perform a method comprising:
evaluating an applicability of an Artificial Intelligent (AI)/Machine Learning (ML) model in relation to a mobile telecommunication network;
generating a report message that includes the evaluated applicability; and
providing the report message to at least one Network Element (NE) of the mobile telecommunication network.
